(19) United States
(12) Patent Application Publication
(10) Pub. No.: US 2026/0083158 A1
(43) Pub. Date: Mar. 26, 2026

(54) EGG SUBSTITUTE COMPOSITIONS

(71) Applicant: Outstanding Foods, Inc., Los Angeles, CA (US)

(72) Inventors: David K. ANDERSON, Thousand Oaks, CA (US); Steven W. BAVIN, Thousand Oaks, CA (US)

(21) Appl. No.: 19/109,511

(22) PCT Filed: Sep. 6, 2023
(86) PCT No.: PCT/US2023/073584

§ 371 Date: Mar. 6, 2025

Related U.S. Application Data
(60) Provisional application No. 63/404,136, filed on Sep. 6, 2022.

(51) Int. Cl. A23L 15/00; A23D 9/00; A23J 3/18; A23L 5/40; A23L 27/40

(52) U.S. Cl. CPC A23L 15/35; A23D 9/00; A23J 3/18; A23L 5/40; A23L 27/40

(57) ABSTRACT

Described herein are egg substitute compositions that are configured to be substituted for a traditional egg as a food product and/or for use in preparing food products. In general, these compositions may include a non-denatured potato protein and a fat, and are formulated to have textural properties and taste equivalent to traditional egg. These egg substitute compositions may be substituted approximately 1:1 for a traditional egg.

### CLAIM OF PRIORITY

This patent application claims priority to U.S. provisional patent application No. 63/404,136, filed on Sep. 6, 2022, titled “EGG SUBSTITUTE COMPOSITIONS” and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Eggs are one of the most common sources of food alone or as an ingredient in a wide variety of recipes. Traditional eggs are produced by domesticated chickens, although other sources of animal eggs include duck, goose, ostrich, quail, emu and pheasant are also used for consumption. Eggs are generally consumed as a low-cost source of animal protein, vitamins and minerals. While eggs have been appreciated for their nutritional value, certain dietary restrictions and health conditions prohibit or suggest reducing their consumption. It has been shown that eggs may contain cholesterol that may contribute to various diseases. Studies have correlated pathogenic microorganisms such as E. coli and salmonella on or inside of eggs to foodborne illnesses. Eggs also contain several compounds such as ovalbumin, lysozyme, ovomucoid, and ovotransferrin that are associated with an allergic response in susceptible individuals. In addition to the objectively negative aspects of egg consumption, obligated or self-imposed diets, such as a vegan diet, restrict participants from eating eggs or egg products entirely. Due to the pervasive inclusion of eggs throughout the food industry, this presents a significant negative impact on culinary options available for these individuals.

Current attempts to provide a substitute for eggs ranging from isolating traditional egg components to complex egg substitute compositions. The isolated egg components, such as egg whites and egg yolks, fail to address the dietary restrictions for those who avoid animal products, as well as the wide applicability of the isolated egg component as an ingredient. The current egg substitute compositions may address dietary restrictions related to animal product consumption, but they fail to provide similar characteristics offered by traditional eggs alone or as an ingredient.

For these reasons, it would be desirable to provide plant-based egg substitute compositions with substantially similar or improved characteristics compared to traditional eggs. It would be particularly desirable to provide a plant-based composition configured to replace a traditional egg as a stand-alone food product or as an ingredient without noticeable differences compared to traditional eggs. At least some of these objectives will be met by the compositions described herein.

### SUMMARY OF THE DISCLOSURE

Described herein are egg substitute compositions that provide a substantial and unexpected improvement in their characteristic similarity to traditional eggs alone and as an egg-substitute for use as an ingredient. These egg substitute compositions are configured to be substituted for a traditional egg as a food product and/or for use in preparing food products and have approximately equivalent textural properties and flavor as that of traditional eggs.

A traditional egg (“native egg”) is comprised of many types of proteins (i.e., ovalbumin, ovotransferrin, ovomucin, and other albumin proteins) and the composition of these proteins may allow a variety of functionally important characteristics, such as emulsification, coagulation, binding, and foaming properties. The egg substitute compositions described herein provide protein-protein and protein-solvent (water) interactions that occur in a multitude of food applications and allow these compositions to replace traditional animal-based eggs, and result in comparable or identical properties (emulsification, coagulation, binding, foaming, etc.) as compared with traditional eggs. The compositions described herein may also replicate the taste and feel (e.g., texture, etc.) of traditional eggs when used in food preparation. In contrast, currently available egg substitutes, even those that may resemble the flavor and color of traditional eggs, fail to provide all or even some of the functional properties of traditional eggs, unlike the egg substitutes described herein.

Specifically, the egg substitutes described herein share many of the critical properties, including coagulation, emulsification, binding, and foaming properties of traditional eggs. Surprisingly, these properties may result, at least in part, due to the use of at least one substantially un-denatured (e.g., have less than x % of denaturation, where x is 15%, 12%, 10%, 8%, 7%, 6%, 5%, 4%, 3%, 2%, 1%, etc.) primary vegetable protein and must include at least 0.25% chloride (Cl—) (e.g., at least 0.2%, 0.3%, 0.4%, 0.5%, 0.6%, 0.7%, 0.8%, 0.9%, 1%, etc. chloride) in order to provide an artificial egg product that coagulates similar to traditional egg coagulation. The primary vegetable protein may be, for example, potato protein. These compositions, which are otherwise slightly acidic, are typically adjusted to have a slightly alkaline pH, e.g., between about 7.1 and 7.8 (e.g., 7.2-7.8).

For example, described herein are egg substitutes that may include 5% to 15% of a substantially non-denatured plant protein isolate (e.g., 5% to 15% substantially non-denatured potato protein (e.g., patatin), 7% to 14% substantially non-denatured potato protein, 8% to 13% substantially non-denatured potato protein, etc.); one or more fat agents (e.g.; 1% to 15% of a fat, such as, e.g., 1%-10% sunflower oil, coconut oil, palm oil, etc.); 0.25%-3% chloride (e.g., 0.2% to 3% NaCl, 0.25% to 3% NaCl, etc.); one or more pH buffering agents to set the pH between 7.1 and 7.9 (e.g., calcium carbonate, tetrasodium pyrophosphate (TSPP), etc.) and water (e.g., 60%-92%). This composition may also include a second vegetable protein isolate (e.g., 3%-10% wheat protein, 5%-11% potato protein, etc.). Optional additional components may include 0%-3.5% each of one or more of: lecithin, gellan gum (low acyl), gellan gum (high acyl), psyllium, flavors (e.g., egg flavor, pea blocker, potato blocker, etc.), plant fiber (e.g., pea fiber), coconut oil, colorants (e.g., beta carotene, titanium dioxide, etc.) and/or xanthan gum. The percentages may refer to the percentage by weight.

In some examples, an egg substitute may comprise 1% to 15% wheat protein (also referred to herein a gluten protein). The quantity of wheat protein can be based on the percentage of the substantially non-denatured potato protein isolate. The egg substitute may include tetrasodium pyrophosphate. The egg substitute compositions described herein may comprise one or more stabilizing agents.

In some examples, the composition may be configured to mix with a sufficient amount of water before use. The plant-based egg substitute may comprise 6% of the substantially non-denatured potato protein isolate. The substantially non-denatured potato protein isolate may be combined with one or more additional proteins. The plant-based egg substitute may comprise between about 3% and 10% of wheat protein, less than 5% sodium chloride, and 60% to 95% water.

The egg substitutes described herein may be configured specifically for one or more of: baking, as an egg white substitute, as an egg yolk substitute and/or as a scramble substitute. The scramble substitute may be used directly for cooking and consumption as a scrambled egg or egg patty substitute. For example, an egg substitute composition for use in baking may comprise a substantially non-denatured potato protein isolate (e.g., between about 7%-15%); sunflower lecithin (less than 3.5%, e.g., between about 1%-3%, etc.); calcium carbonate (e.g., between about 0.01%-3.5%, e.g., between about 0.7%-1%); plant fiber (e.g., pea fiber; e.g., less than 3.5%, e.g., between about 1%-3%); a chloride (less than 1%, e.g., between about 0.3% and 0.8%, etc. of NaCl); tetrasodium pyrophosphate (TSPP, between about 0.5 to 3.5%, e.g., between about 0.7% and 1.3%); and a fat, e.g., one or more of sunflower oil (between about 4%-7%), coconut oil (between about 1%-10%) and/or palm oil (between about 1%-10%). The pH is between 7.1 and 7.8 (e.g., between 7.2-7.8). Optionally, the egg substitute for baking may include colors (e.g., beta carotene and/or titanium dioxide, between about 0.1%-2%). The composition can be configured to be combined with water (e.g., as an aqueous solution) and may be used to substitute (approximately 1:1 by weight) as an egg in a baking process.

In any of these compositions, the egg substitute may comprise between about 1% to 15% wheat protein, the quantity of wheat protein may be based on the percentage of the substantially non-denatured potato protein isolate.

In general, the fat may be a high linoleic acid oil such as a sunflower oil. Alternatively or additionally, the fat may be rich in medium chain triglycerides (e.g., coconut oil, palm oil, etc.).

The egg substitute may comprise one or more stabilizing agents. The plant-based egg substitute may comprise one or more compounds selected from the group consisting essentially of low acyl gellan gum, high acyl gellan gum, psyllium, tetrasodium pyrophosphate. The composition may also include one or more flavorants/flavors (e.g., pea blocker, potato blocker, etc.) plant fiber (e.g., pea fiber). The egg substitute composition may include one or more colorant, e.g., beta carotene, titanium dioxide, and xanthan gum. The plant-based egg substitute may comprise between about 60% and 95% water. In some examples, the plant-based egg substitute comprises between about 5% and 10% of the substantially non-denatured potato protein isolate. The substantially non-denatured potato protein isolate may be combined with one or more additional proteins. The plant-based egg substitute may comprise between about 3% and 10% of wheat protein, less than 5% sodium chloride, and 60% to 95% water.

For example, described herein are egg substitute compositions comprising: 5% to 15% by weight of a substantially non-denatured potato protein isolate; 1% to 25% by weight of a fat; 0.3% to 3% by weight of chloride; one or more of calcium carbonate, tetrasodium pyrophosphate (TSPP), etc., and between about 94% to 50% by weight of water, wherein the egg substitute composition has a pH between 7.1 and 7.8 and coagulates equivalently to a traditional egg.

The substantially non-denatured potato protein isolate may be 35% denatured or less (e.g., 30% denatured or less, 25% denatured or less, 20% denatured or less, 15% denatured or less, 10% denatured or less, 8% denatured or less, 7% denatured or less, 6% denatured or less, 5% denatured or less, 2% denatured or less, 1% denatured or less, etc.). The potato protein isolate may be patatin. In any of these examples the potato protein isolate is nondenatured patatin.

The fat may comprise an oil, such as a plant-based (e.g., vegetable oil). In some examples, the fat has a linoleic acid content of 45% or greater (e.g., 50% or greater, 55% or greater, 60% or greater, etc.). For example, the oil may comprise a sunflower oil.

An of these compositions may include a second protein isolate. For example, any of these compositions may include between about 3% and 21% by weight of a second protein isolate. The second protein isolate, and the substantially non-denatured potato protein isolate may comprise 16% by weight or less of the composition (e.g., with a minimum of 5% by weight of the non-denatured potato protein isolate). The second protein isolate may be a vegetable protein isolate. The second protein isolate may be one of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate. For example, the egg substitute composition may include between about 1% to 15% by weight of pea protein isolate, wherein a total amount of pea protein isolate, and the substantially non-denatured potato protein isolate is 16% by weight or less.

Any of these egg substitute compositions may include a pH buffer, such as one or more of: calcium sulfate, tetrasodium pyrophosphate and/or sodium acid pyrophosphate. The amount of the pH buffer may be sufficient to set the pH of the egg substitute composition to between 7.1 and 7.8 or between 7.2 and 7.8.

The compositions described herein may include one or more additional components, wherein each additional component is present at less than 3.5%, further wherein the additional components comprise: plant lecithin, calcium carbonate, low acyl gellan gum, high acyl gellan gum, psyllium, tetrasodium pyrophosphate, pea blocker, potato blocker, plant fiber, beta carotene, titanium dioxide, and xanthan gum.

The egg substitute compositions described herein may include one or more food colorants. For example, the one or more food colorants may comprise one or both of between about 0.05%-2.0% by weight of beta carotene and between about 0.05%-2.0% by weight of titanium dioxide.

In general, the egg substitute compositions described herein do not need to include transglutaminase or methylcellulose, or additional coagulants.

In general, the egg substitute compositions described herein may be configured for baking. For example, the composition may include: between about 7%-15% by weight of the substantially non-denatured potato protein isolate, between about 0.01%-3.5% by weight of a plant lecithin, between about 0.01%-3.5% by weight of a calcium carbonate, between about 0.01%-3.5% by weight a pea fiber, between about 0.25%-3.5% by weight of the chloride, between about 0.7%-1.3% by weight of a tetrasodium pyrophosphate, and between about 4%-10% by weight of the fat, wherein the fat comprises an oil. The pH may be set to between 7.2 and 7.8. The oil may comprise between about 4%-10% by weight of sunflower oil and between about 1%-10% by weight coconut oil or palm oil.

The egg substitute composition may be configured for a fried preparation. For example, the composition may comprise: between about 7%-15% by weight of the substantially non-denatured potato protein isolate, between about 0.01%-3.5% by weight of a plant lecithin, between about 0.01%-3.5% by weight of a calcium carbonate, between about 0.25%-3.5% by weight of the chloride, between about 0.4%-3.0% by weight of a tetrasodium pyrophosphate, between about 5%-12% by weight of the fat, wherein the fat comprises an oil. The pH of the composition may be set to between about 7.2 and 7.8. The composition may further comprise between about 1%-3.5% by weight of an inulin.

The egg substitute composition may be configured as an egg yolk substitute. For example, the egg substitute composition may include: between about 10%-15% of the substantially non-denatured potato protein isolate, between about 0.25%-3.5% of a chloride, between about 2%-6% of a plant lecithin, between about 1%-4% of a calcium carbonate, between about 0.5-2.5% a plant fiber, between about 0.4-3.5% of a tetrasodium pyrophosphate, between about 15-25% the fat, wherein the fat comprises an oil. The pH may be set to between 7.1 and 7.8 (e.g., 7.2-7.8).

In some examples a plant-based egg substitute composition for use in baking may include: between about 7%-15% by weight of a substantially non-denatured potato protein isolate; greater than about 0.25% of a chloride; a plant lecithin; a calcium carbonate; a plant fiber; a sodium pyrophosphate; a vegetable oil; and water, wherein the composition has a pH between 7.1-7.8 (e.g., 7.2-7.8) and is configured to substitute for an egg in a baked food product and wherein the composition coagulates equivalently to a traditional egg. The composition may further include between about 1% to 15% of a second protein isolate, wherein the second protein isolate is one or more of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate. For example the composition may include between about 1% and 15% of pea or wheat protein. The vegetable oil may be a sunflower oil and/or coconut oil and/or palm oil. The plant lecithin may be between about 0.01%-3.5% by weight, the calcium carbonate may be between about 0.01%-3.5% by weight, the plant fiber may be between about 0.25%-3.5% by weight, the chloride may be between about 0.01%-3.5% by weight, the sodium pyrophosphate may be between about 0.7% and 1.3% by weight, and the oil may be between about 4%-10% by weight. The plant lecithin may comprise sunflower lecithin. The plant fiber may comprise pea fiber. The chloride may comprise NaCl. Any of these compositions may include between about 0.5% to 2% by weight of calcium sulfate and may have pH set to between 7.1 and 7.8.

For example, a plant-based egg substitute composition for frying may include: between about 7%-15% by weight of a substantially non-denatured potato protein isolate; greater than about 0.25% of a chloride; a plant lecithin; a calcium carbonate; a plant fiber; a tetrasodium pyrophosphate; a vegetable oil; and water, wherein the composition is configured to substitute for an egg in a baked food product and wherein the composition coagulates equivalently to a traditional egg. The plant lecithin may comprise between about 0.01%-3.5% by weight, the calcium carbonate may comprise between about 0.01%-3.5% by weight, herein the chloride may comprise between about 0.25%-3.5% by weight, wherein the tetrasodium pyrophosphate may comprise between about 0.4%-3.5% by weight, and the vegetable oil may comprise between about 5%-12% by weight. The composition may include between about 1%-3.5% by weight of an inulin. For example, the composition may include between about 1%-3.5% by weight of an inulin, between about 0.1%-0.4% by weight of a beta carotene and between about 0.05%-0.2% by weight of a titanium dioxide.

As mentioned, any of these compositions may include between about 1% to 15% of a second protein isolate, wherein the second protein isolate is one or more of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate. For example, the composition may include between about 1% and 15% of pea or wheat protein. The vegetable oil may be a sunflower oil, coconut oil and/or palm oil. The plant lecithin may comprise sunflower lecithin. The plant fiber may be a pea fiber. The chloride may be from NaCl. The composition may further include between about 0.5% to 2% by weight of calcium sulfate.

Also described herein are plant-based egg-white substitute compositions, comprising: between about 10%-15% by weight of a substantially non-denatured potato protein isolate; greater than about 0.25% of a chloride; a calcium carbonate; a tetrasodium pyrophosphate; and water, wherein the composition has a pH of between 7.1-7.8 and is configured to substitute for an egg white in a food product and wherein the composition coagulates equivalently to a traditional egg. The composition may further comprise: between about 0.25%-3.5% of the chloride, between about 1%-4% of the calcium carbonate, and between about 0.4%-3.5% of the tetrasodium pyrophosphate. The composition may include a colorant (e.g., between about 0.1%-2.0% of a titanium dioxide).

Also described herein are plant-based egg yolk substitute compositions, comprising: between about 10%-15% by weight of a substantially non-denatured potato protein isolate; greater than about 0.25% of a chloride; a calcium carbonate; a plant lecithin; a plant fiber; a tetrasodium pyrophosphate; an oil; and water, wherein the composition has a pH between 7.1 and 7.8 (e.g., 7.2-7.9) and is configured to substitute for an egg yolk in a food product and wherein the composition coagulates equivalently to a traditional egg.

The composition may optionally include between about 0.25%-3.5% of the chloride, between about 2%-6% of the plant lecithin, between about 1%-4% of the calcium carbonate, between about 0.5-2.5% a plant fiber, between about 0.4-3.5% of the tetrasodium pyrophosphate, between about 15-25% the oil. Any of these compositions may include between about 0.3%-3.0% of a colorant (e.g., beta carotene). Any of these compositions may include between about 1% to 15% of a second protein isolate, wherein the second protein isolate is one or more of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate. The composition may include between about 1% and 15% of pea or wheat protein. The composition may include between about 0.5% to 2% by weight of calcium sulfate.

Also described herein are food or beverage compositions comprising any of the egg substitute compositions described herein. The food or beverage composition may be selected from the group consisting of: an egg-free scramble, an egg-free pancake, an egg-free waffle, an egg-free brownie, an egg-free muffin, an egg-free pasta, an egg-free cookie, an egg-free cake, an egg-free quiche, an egg-free frittata, an egg-free tempura, an egg-free ice Cream, an egg-free gelato, an egg-free pancake, an egg-free frosting, an egg-free cheesecake, an egg-free angel food cake, an egg-free macaron, an egg-free meringue cookie, an egg-free marshmallow, an egg-free souffle, an egg-free crème Brule, an egg-free custard, an egg-free mayonnaise, an egg-free aioli, an egg-free hollandaise. The egg substitute may be used in an approximately 1:1 substitution ratio for a traditional egg in any of these foods or beverages.

For example, described herein are egg substitute compositions comprising: 5% to 15% by weight of a substantially non-denatured potato protein isolate; 1% to 25% by weight of a fat; 0.3% to 3% by weight of chloride; one or more of: calcium carbonate between 0.01%-3.5% by weight, tetrasodium pyrophosphate between 0.7%-1.3% by weight, and sodium acid pyrophosphate between 0.5 to 2% by weight; and between 94% to 50% by weight of water, wherein the pH is between 7.2 and 7.8, and wherein the egg substitute composition coagulates equivalently to a traditional egg. The substantially non-denatured potato protein isolate may comprise non-denatured patatin. In some examples the substantially non-denatured potato protein isolate is 35% denatured or less. The fat may comprise at least 2% medium chain fatty acids having an alkyl chain length 12 or less (e.g., MCTs). The fat may comprise 3% or more by weight of coconut oil and/or 3% or more by weight of palm oil. In any of these examples, the egg substitute composition, when cooked to an internal temperature of between 160-170 degrees, has a firmness of within 35% that of a traditional egg. For example, the egg substitute composition, when cooked to an internal temperature of between 160-170 degrees, may have a firmness of between 6800 g and 3200 g.

In some examples, a plant-based egg substitute composition includes: between 10%-15% by weight of a non-denatured potato protein isolate; greater than 0.25% by weight of a chloride; one or more of: calcium carbonate, between 0.01%-3.5% by weight, tetrasodium pyrophosphate between 0.7%-1.3% by weight, and sodium acid pyrophosphate between 0.5 to 2% by weight; and water, wherein the egg substitute composition, when cooked to an internal temperature of between 160-170 degrees, has a firmness of within 35% that of a traditional egg.

Also described herein are methods of making any of these egg substitute compositions. For example, a method of making an egg substitute composition may include: combining, into water, 5% to 15% by weight of a non-denatured potato protein isolate, 1% to 25% by weight of a fat, 0.25% to 3% by weight of chloride; and adjusting the pH to be between 7.2 and 7.8 by adding one or more of: calcium carbonate, between 0.01%-3.5% by weight, tetrasodium pyrophosphate between 0.7%-1.3% by weight, and sodium acid pyrophosphate between 0.5 to 2% by weight, wherein the egg substitute composition coagulates equivalently to a traditional egg.

For example a method of making an egg substitute composition may include: combining, in water: about 5% to 15% by weight of a substantially non-denatured potato protein isolate, about 1% to 25% by weight of a fat, about 0.25% to 3% by weight of chloride; and adjusting the pH to between 7.1 and 7.8 by adding and one or more of: calcium carbonate, tetrasodium pyrophosphate, and sodium acid pyrophosphate, wherein the egg substitute composition has textural properties equivalent to a traditional egg.

A method of making an egg substitute composition for baking may include: combining: between about 7%-15% by weight of a substantially non-denatured potato protein isolate, a plant lecithin, a calcium carbonate, a plant fiber, a chloride, a tetrasodium pyrophosphate, a vegetable oil; and water, to have a pH of between 7.1 and 7.9 to form the egg substitute composition, wherein the composition is configured to substitute for an egg in a baked food product and wherein the composition coagulates equivalently to a traditional egg.

The egg substitute compositions described herein may in general provide egg substitutes that mimic the functionality of a whole egg, egg white, and egg yolk and may allow substitution (e.g., 1:1 substitution by weight) in virtually any recipe in which a traditional egg is used. The compositions described herein may be configured as complete egg substitution (e.g., egg white and egg yolk substitution), egg white substitution, and/or egg yolk substitution. These compositions may provide the functionality of traditional eggs (i.e., coagulation, emulsification, and binding) in a manner that is not addressed with the currently described and offered plant-based substitutes; although previously described (and commercialized) plant-based egg substitutes may mimic the color and flavor of a whole egg, they typically fail to provide all of the functionality of a traditional egg, and cannot be used to replace eggs a variety of uses, such as both frying and baking and/or emulsification.

In addition, the egg substitute compositions described herein are plant-based egg substitutes that also address the various difficulties with traditional eggs and other proposed egg substitutes, such as food safety concerns, health concerns, and dietary restriction issues. For example, the compositions described herein have a very low cholesterol, as they may use plant-derived oils, which have little if any cholesterol.

All of the methods and apparatuses described herein, in any combination, are herein contemplated and can be used to achieve the benefits as described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A better understanding of the features and advantages of the methods and apparatuses described herein will be obtained by reference to the following detailed description that sets forth illustrative embodiments, and the accompanying drawings of which:

FIG. 1 is an image of example of food product configured as a scramble prepared from an egg substitute composition as described herein.

FIGS. 2A-2E illustrate the importance of the use of a substantially non-denatured plant protein isolate (e.g., non-denatured potato protein isolate) to the formulation of the egg substitute as described herein. FIG. 2A shows a successful scramble preparation using a substantially un-denatured protein, showing coagulation and textural properties similar to traditional eggs. FIG. 2B shows the same preparation as in FIG. 2A, formulated with denatured potato protein isolate; this composition failed to coagulate. Similarly, FIGS. 2C-2E illustrate the use of wheat protein (from wheat flour), pea protein and lentil protein, respectively, each also failing to coagulate or gel when prepared as a scramble.

FIGS. 3A-3G illustrate examples of compositions outside (e.g., FIGS. 3A-3E) and within (FIGS. 3F-3G) of the ranges of components for the egg substitute compositions as described herein, prepared as a scramble.

FIGS. 4A-4D illustrate the dependence of chloride (but not sodium) on the coagulation and gelling of the egg substitute compositions described herein. FIG. 4A shows a preparation of an egg substitute compositions similar to that described above, but with salt (NaCl) omitted and replaced and with one of the following: MgCl₂ (FIG. 4A), CaCl₂ (FIG. 4B), sodium bicarbonate (NaHCO₃, FIG. 4C), Sodium Acid pyrophosphate (Na₂H₂P₂O₇, FIG. 4D) added instead. As seen in FIGS. 4A-4B compositions including chloride, even without sodium, coagulated similarly to traditional eggs.

FIG. 5A shows a comparison of a baked food product (e.g., brownies) prepared using either the egg substitute composition described herein or a commercially available egg substitute). As compared to other commercially available egg substitute products, only the egg substitute compositions described provided baked goods having the textural, coagulation, emulsification and binding comparable with traditional eggs, resulting in a baked food product that was indistinguishable one prepared with traditional eggs.

FIG. 5B is an image of a control baked food product (prepared identically to those of FIG. 5A, using traditional eggs).

FIG. 6 is an image comparison of the baked food products comprising an egg substitute as described herein with other commercially available egg substitutes.

FIG. 7A is a graph comparing the texture (shearing texture) of a control baked food product to a baked food product prepared using the egg substitute described herein, as well as to other commercially available egg substitute products, showing that the baked food products prepared with the egg substitutes described herein had shearing properties that were much more similar to baked food products prepared with traditional eggs than baked food products prepared with other commercially available food products.

FIG. 7B is a table showing example quantitate data corresponding to the graphs shown in FIG. 7A.

FIG. 8A is a graph comparing the texture (relaxation texture) of a control baked food product to a baked food product prepared using the egg substitute described herein, as well as to other commercially available egg substitute products, showing that the baked food products prepared with the egg substitutes described herein had relaxation textural properties that were much more similar to baked food products prepared with traditional eggs than baked food products prepared with other commercially available food products.

FIG. 8B is a table showing example quantitate data corresponding to the graphs shown in FIG. 8A.

FIG. 9A is a graph comparing the texture (compression texture) of a control baked food product to a baked food product prepared using the egg substitute described herein, as well as to other commercially available egg substitute products, showing that the baked food products prepared with the egg substitutes described herein had compression textural properties that were much more similar to baked food products prepared with traditional eggs than baked food products prepared with other commercially available food products.

FIG. 9B is a table showing example quantitate data corresponding to the graphs shown in FIG. 9A.

FIGS. 10A-10B show examples of texture analyzer data comparing the firmness of a (cooked) traditional egg with variations of the egg substitute compositions described herein, and with an example of a commercially available egg substitute.

FIG. 11 shows examples of texture analyzer data comparing the resilience of a (cooked) traditional egg with variations of the egg substitute compositions described herein, and with an example of a commercially available egg substitute.

FIG. 12 shows examples of texture analyzer data comparing the springiness of a (cooked) traditional egg with variations of the egg substitute compositions described herein, and with an example of a commercially available egg substitute.

### DETAILED DESCRIPTION

Described herein are egg substitute composition that do not contain traditional eggs and replicate or approximate the functional behavior of traditional eggs in food preparation, including, but not limited to coagulation, emulsification, binding, foaming, and the like. Specifically, the egg substitute compositions described herein, unlike other commercially available egg substitute compositions are suitable for frying (e.g., as a “scramble” preparation) as well as baking, and emulsifying. In general, the egg substitute compositions described herein may include a substantially non-denatured isolated protein (and in particular, a substantially non-denatured isolated potato protein) as well as a predetermined amount of chloride (e.g., as from NaCl or other edible chloride source(s)), and fat (e.g., oils, and in particular vegetable oils) in an aqueous solution. In some examples, the compositions described herein may comprise one or more additional components (e.g., secondary protein, secondary fat, hydrocolloids, leavening agents, coloring agents, flavoring agents, emulsifiers, flours, fibers, etc.) in a ratio based on weight.

Any of the compositions described herein may be configured to substitute an egg as a food product for direct consumption or as a substitute for an egg in any application aside from direct consumption. In some examples, any composition described herein may be configured to form a homogenous or heterogenous mixture with water.

The egg substitute compositions described herein may include components based on the biochemical activity of the component (e.g., binding capabilities). For example, any composition described herein may comprise one or more hydrocolloids. Hydrocolloids described herein may be configured to form hydrocolloid systems and any composition described herein may comprise one or more hydrocolloid agents based on their capability of forming structural elements. Another example may include selection of one or more proteins incorporated into the composition based on the protein structure and capability to form structural systems (e.g., matrices) within the composition. In some examples, the structural systems formed by one or more components of any composition described herein may be configured to retain and/or incorporate liquid (e.g., water) and/or gas (e.g., air).

As used herein, any of these compositions may include one or more natural (e.g., vegetable) fats, such as a vegetable oil. A vegetable oil may be a plant-based oil. For example a vegetable oil may be one or more of: grapeseed oil, avocado oil, safflower oil, peanut oil, palm oil and coconut oil. In some examples, it may be particularly beneficial to include coconut oil and/or palm oil either alone or in combination with a second vegetable oil.

As used herein a protein isolate may refer to a protein that is extracted from some the native plant material from which the protein was formed. A protein isolate does not have to be completely pure. For example, a protein isolate may be more than 50% pure, more than 60% pure, more than 70% pure, more than 80% pure, more than 90% pure, more than 95% pure, more than 98% pure, etc.

As mentioned, the protein isolate may preferably be a potato protein isolate, which may include patatin. Patatin may typically be found in tubers, such as tubers of potato (Solanum tuberosum) as storage protein. Storage protein may store for nitrogen, sulfur and/or carbon, enabling the plant to survive periods of adverse growth conditions or between growing seasons. Storage protein is generally present in a quantity of 40-50 wt. % of all protein in the tuber. Storage protein can generally be characterized by a molecular weight of 35-50 kDa, preferably 38-45 kDa and/or by an isoelectric point of 4.8-5.6. The molecular weight can be determined by commonly known methods, such as SDS page. The isoelectric point can also be determined by commonly known methods, such as for example isoelectric focusing. As used herein, non-denatured potato protein may include non-denatured patatin and may be a protein isolate. The non-denatured potato protein may be enriched for patatin, e.g., may include at least 75 wt. % of patatin, at least 85 wt. %, etc. In some examples the potato protein may be a patatin isolate.

The non-denatured potato protein isolate may be obtained in any appropriate manner, including by the method to isolate native patatin described, e.g., in WO2008/069650, although other methods may be used. The non-denatured potato protein may be unmodified, such as unmodified by crosslinking or complexation.

In general, and as described herein, the egg substitutes described herein may have properties equivalent or nearly equivalent to traditional eggs. As used herein a traditional egg refers to a traditional egg, such as a chicken egg.

The isolated proteins described herein may be substantially non-denatured. Non-denatured may also be referred to herein as undenatured. Denaturation, in the context of the isolated vegetable proteins described herein, refers to a change in the tertiary and/or quaternary structure and/or properties of the vegetable protein typically caused by heat or chemical reaction that alters a tertiary and/or quaternary structure of the protein. An isolated protein may be denatured when its structure deviates from its native conformation (e.g., it's structure in the vegetable from which it is purified). As used herein an isolated protein is substantially non-denatured if it includes a substantial amount (by weight percent) of non-denatured isolated protein. For example, an isolated plant protein as described herein that is substantially non-denatured may be 100%, 99% or more, 95% or more, 90% or more, 85% or more, 80% or more, 75% or more, 70% or more, 65% or more, 60% or more, 55% or more, 50% or more, 45% or more, 40% or more, 35% or more, 30% or more, 25% or more non-denatured. The amount of non-denatured isolated protein may be greater than the amount of denatured protein in the same aggregate total isolated protein included in the composition. The process of protein extraction and isolation may include methods of extraction and isolation configured to retain the natural (e.g., non-denatured) configuration of the subject protein structure. The extent a protein is denatured may be determined by any of a variety of methods known in the art (e.g., electrophoresis, differential scanning calorimetry, optical absorption, etc.).

The non-denatured isolated proteins described herein can have improved binding activity corresponding to unexpected improvements in the characteristics and attributes of the composition as an egg substitute as compared to denatured version of the same isolated proteins. In some examples the protein isolated while remaining substantially non-denatured by extraction techniques such as chromatography (e.g., column chromatography). For example, non-denatured proteins may be isolated in a manner sufficient to prevent structural deformation of the subject proteins. Proteins, as described herein, may be sufficiently non-denatured to support binding to any other component or constituent of the composition described here. In some examples, the non-denatured proteins are configured to form and/or participate in the formation of a matrix structures to support gelation of the composition when mixed with a liquid (e.g., water).

In general, the egg substitute compositions described herein may include: a substantially non-denatured potato protein isolate (e.g., from 5% to 20% by weight, from about 5% to 18%, from about 5% to 17%, from about 5% to 16%, from about 5% to 15%, from about 7% to 16%, from about 8% to 16%, etc.), a chloride (e.g., from about 0.25% to 3% by weight), and between about 94% to 40% by weight of water. These compositions may also include a fat (e.g., vegetable oil), such as between about 1% to 25% by weight of the fat. The substantially non-denatured potato protein isolate may be 60% denatured or less (e.g., 50% denatured or less, 40% denatured or less, 35% denatured or less, 30% denatured or less, 25% denatured or less, 20% or less, 15% denatured or less, 13% denatured or less, 10% denatured or less, 8% denatured or less, 5% denatured or less, etc.). Denaturation may change the solubility, and may result in a conformational change and loss of solubility to aggregation due to the exposure of hydrophobic groups in the protein; the loss of solubility as a result of denaturation (coagulation) may be detected by a variety of methods known to those of skill in the art. In general, the percentage of denaturation may be determined by any appropriate method. For example, the percentage of denaturation may be determined by chemical analysis. In some examples the percentage of denaturation may be determined by electrophoresis (e.g., SDS page). Other methods of determining the percentage of denaturation may include: high sensitivity differential scanning calorimetry (DSC), optical absorption (e.g., fluorescence spectroscopy, circular dichroism, etc.)), centrifugation, etc.

In general, these egg substitute compositions may include a fat comprising an oil. The oil may have a linoleic acid content of greater than 45%. In some examples the oil may comprise a sunflower oil.

Any of the compositions described herein may include a second protein isolate (e.g., a second vegetable protein isolate). The amount of second protein isolate may be selected based on the amount of the requisite substantially non-denatured potato protein isolate. For example, the amount of the secondary protein may be between about 3% and 21% by weight of the second protein isolate. In some examples the total amount of isolated protein in the composition may be about 25% or less (e.g., 24% or less, 23% or less, 22% or less, 21% or less, 20% or less, 19% or less, 18% or less, 17% or less, 16% or less, 15% or less, etc.) and thus the amount of the second protein may be determined as the difference of the total amount of isolated protein by weight and the substantially non-denatured potato protein isolate. For example, the total of the second protein and the substantially non-denatured potato protein isolate may be about 16% by weight or less.

In general the second protein isolate may be a vegetable protein isolate. In some examples the second protein isolate may also be substantially non-denatured. The second protein isolate may be, for example, one of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate. In some examples the second protein isolate may be a nut protein isolate. Nut protein isolates may not be preferred in order to avoid potential food allergy concerns. In some cases the second protein isolate may be pea protein. In some cases the second protein isolate may be a wheat protein (e.g., gluten protein). Pea proteins may be used where the egg substitute may be formulated as gluten-free. For example, the egg substitute composition may include between about 1% to 15% by weight of pea protein isolate (and in some examples a total amount of pea protein isolate, and the substantially non-denatured potato protein isolate is 16% by weight or less).

The egg substitute compositions described herein may include one or more pH buffers. In some examples the pH of the egg substitute is between about 7.8 and 6.5. In some cases the pH is adjusted to be no less than 7.0 (e.g., between 7.1 and 7.6). For example, any of the compositions described herein may include calcium sulfate (e.g., between about 0.5% to 2% by weight of calcium sulfate) and sodium pyrophosphate (e.g., between 0.4% and 0.8%). As described in greater detail here, it is particularly beneficial that the pH be slightly alkali (e.g., between 7.1 and 7.8).

Any of the egg substitute compositions described herein may include tetrasodium pyrophosphate (e.g., between about 0.1% and about 5% (e.g., between about 1% and about 4%, between about 1.8% and 2.2%, etc.).

In general, the egg substitute compositions described herein may include one or more additional components, wherein each additional component is present at less than 3.5%. Examples of these additional components may include comprise: plant lecithin, calcium carbonate, low acyl gellan gum, high acyl gellan gum, psyllium, tetrasodium pyrophosphate, flavors (e.g., pea blocker, potato blocker, etc.), plant fiber, coconut oil, beta carotene, titanium dioxide, and xanthan gum. Additional colorants (natural, plant-based colorants) and/or flavorants may be included.

In general, the egg substitute compositions described herein may not include transglutaminase or methylcellulose.

As mentioned above, in general the substantially un-denatured potato protein egg substitutes described herein may replicate or approximate the properties of traditional eggs, particularly in mimicking the functionality of traditional eggs in a wide variety of culinary applications for which eggs have traditionally been used, including frying (“scramble”), baking and emulsification. This versatility is unlike other previously described and commercially available egg substitution products, such as those based on mung-bean protein (see, e.g., U.S. Pat. No. 11,266,163) or hydrocolloid-based compositions (see, e.g., U.S. Pat. No. 10,070,655). The versatility and functionality of the compositions described herein may be a result, at least in part, due to the ability of these un-denatured potato protein egg substitutes to replicate properties such as coagulation, emulsification, foaming and binding.

For example, coagulation may refer to the ability of the egg substitute to form a three-dimensional network of protein aggregates when heated. The un-denatured potato protein egg substitutes described herein may coagulate in a manner that is similar or identical to traditional eggs and the resulting coagulated product may have mechanical and chemical properties that are similar or identical to those of traditional eggs. For example, the un-denatured potato protein egg substitutes described herein may interact readily through chemical and physical bonds to form protein aggregates that participate in the formation of a gel network to mimic the appearance of a scrambled egg.

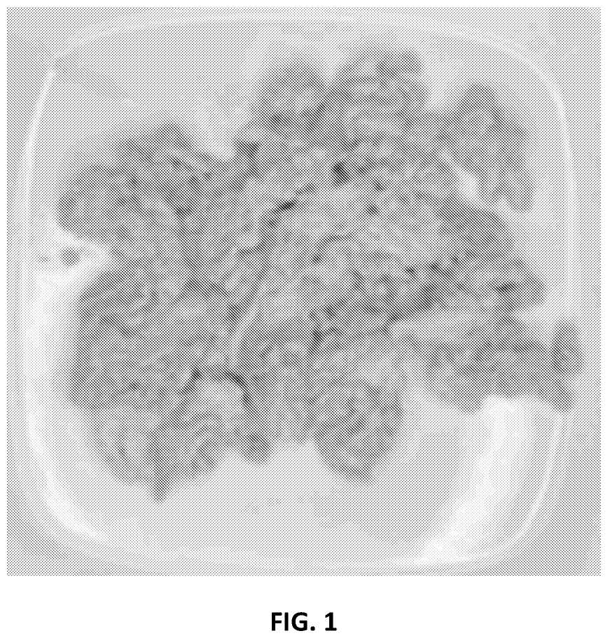

This is illustrated in FIG. 1. FIG. 1 shows an image of an example of an un-denatured potato protein egg substitute composition that has been prepared as a scramble in which the un-denatured potato protein egg substitute composition has been coagulated by frying (e.g., heat) on a typical cooking surface (e.g., frying pan over a gas flame at medium-high heat). The resulting coagulated un-denatured potato protein egg substitute has the texture, size and taste equivalent to that of a traditional egg. By comparison, the traditional egg prepared the same way has a similar or identical appearance and texture, with equivalent particle sizes. These properties may be quantified, e.g., on a texture analyzer. In FIG. 1, the un-denatured potato protein egg substitute composition includes water (70.45%), un-denatured potato protein isolate (7.75%), sunflower lecithin (1.41% of an approx. 3% sunflower lecithin), calcium carbonate (2.11%), inulin (2.11%), tetrasodium pyrophosphate (0.70%), egg flavor (FS 021822C) (1.41%), salt (0.70%), wheat protein (e.g., wheat flour) (4.23%), sunflower oil (6.34%), coconut Oil (2.11%), beta carotene (0.56%) and titanium dioxide (0.11%).

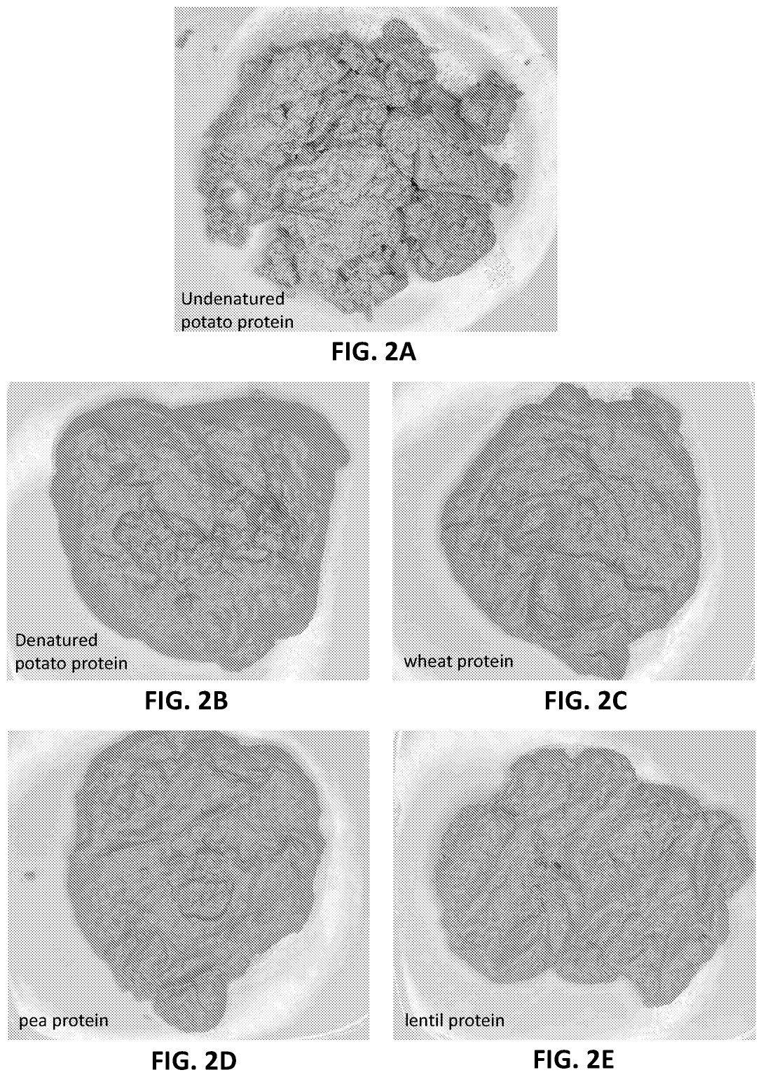

As described, the specific ranges of the components making up the un-denatured potato protein egg substitutes compositions described herein may be critical to replicating the properties of traditional eggs. In particular, the un-denatured potato protein isolate, and in particular the range of un-denatured potato protein isolate (e.g., within about 5% to 20%) in addition to the use of at least 0.5% of chloride (e.g., NaCl or other food-safe source of chloride) have been found, and are shown in FIGS. 2A-2E, 3A-3G and 4A-4D, to be important if not essential. Outside of the specified materials and ranges described herein, the compositions do not mimic the behavior of traditional eggs.

For example, FIGS. 2A-2E illustrate the importance of the use of un-denatured protein (and in particular un-denatured potato protein) in achieving coagulation that is equivalent to traditional eggs. In FIG. 2A, an un-denatured potato protein composition is shown. In this example the composition is formed using approximately 8% of an un-denatured isolated potato protein, along with sunflower lecithin (1.41% of an approx. 3% sunflower lecithin), calcium carbonate (2.13%), gellan gum (high) (0.18%), gellan gum (low) (0.53%), psyllium husk (0.35%), sodium pyrophosphate (0.71%), egg flavor (1.42%), pea blocker (0.18%), potato blocker (0.18%), salt (NaCl) (0.71%), pea protein isolate (4.96%), sunflower oil (6.38%), coconut oil (2.13%), beta carotene (0.50%) and titanium dioxide (0.28%)

As in FIG. 1, when the composition was fried to form a ‘scramble’ by pan-frying the composition, the resulting composition coagulated approximately equivalently to a traditional egg, if not slightly faster. The resulting coagulation had similar or identical texture, size and wetness as traditional eggs prepared identically.

For comparison, when other protein isolates were prepared in the same background and at approximately equivalent percentages, they failed to coagulate in the same manner as traditional eggs. For example, FIG. 2B shows an example of a denatured potato protein. In this example the same un-denatured potato protein isolate was first denatured (by applying heat) and used in the same prototype formulation as in FIG. 2A. This composition included water (70.87%), potato protein isolate (denatured) (7.09%), sunflower lecithin (1.41% of an approx. 3% sunflower lecithin), calcium carbonate (2.13%), gellan gum (high) (0.18%), gellan gum (low) (0.53%), psyllium husk (0.35%), sodium pyrophosphate (0.71%), egg flavor (1.42%), pea blocker (0.18%), potato blocker (0.18%), salt (NaCl) (0.71%), pea protein isolate (4.96%), sunflower oil (6.38%), coconut oil (2.13%), beta carotene (0.50%) and titanium dioxide (0.28%). As shown the resulting preparation did not coagulate into large clumps as in FIG. 2A (and as a traditional egg does) but remained a substantially liquid composition. Similarly when other commercially available plant protein analytes were compared (in FIGS. 2C-2E), the resulting equivalently heated compositions also failed to coagulate as a traditional egg or as the un-denatured potato protein (compare to FIG. 2A). For example, FIG. 2C shows an example of a composition in which wheat protein is used. This composition included wheat protein isolate (13.88%), sunflower lecithin (1.39% of an approx. 3% sunflower lecithin), calcium carbonate (2.08%), gellan gum (high) (0.17%), gellan gum (low) (0.52%), psyllium husk (0.35%), sodium pyrophosphate (0.69%), egg flavor (1.39%), pea blocker (0.17%), potato blocker (0.17%), salt (NaCl) (0.71%), sunflower oil (6.25%), coconut oil (2.08%), beta carotene (0.49%) and titanium dioxide (0.28%), and water (70.87%).

FIG. 2D shows an example of a composition of pea protein. This composition included pea protein isolate (13.28%), sunflower lecithin (1.40% of an approx. 3% sunflower lecithin), calcium carbonate (2.10%), gellan gum (high) (0.17%), gellan gum (low) (0.52%), psyllium husk (0.35%), sodium pyrophosphate (0.70%), egg flavor (1.40%), pea blocker (0.17%), potato blocker (0.17%), salt (NaCl) (0.70%), sunflower oil (6.29%), coconut oil (2.10%), beta carotene (0.49%) and titanium dioxide (0.28%), and water (69.88%). As in FIGS. 2B and 2C, the resulting heated (fried) composition failed to coagulate similarly to a traditional egg. Finally FIG. 2E shows an example in which commercially available lentil protein was used in the composition. For example, the lentil protein composition included lentil isolate (19.99%), sunflower lecithin (1.29% of an approx. 3% sunflower lecithin), calcium carbonate (1.93%), gellan gum (high) (0.16%), gellan gum (low) (0.48%), psyllium husk (0.32%), sodium pyrophosphate (0.64%), egg flavor (1.29%), pea blocker (0.16%), potato blocker (0.16%), salt (NaCl) (0.64%), sunflower oil (5.8%), coconut oil (1.93%), beta carotene (0.45%) and titanium dioxide (0.26%), and water (64.47%). The lentil protein composition, unlike the substantially non-denatured potato protein composition, failed to replicate the coagulation property of a traditional egg. None of the denatured potato protein isolate, wheat protein, pea protein, or lentil protein coagulated/gelled similar to native protein. However, the substantially un-denatured potato protein result in similar or identical coagulation characteristic as a traditional egg.

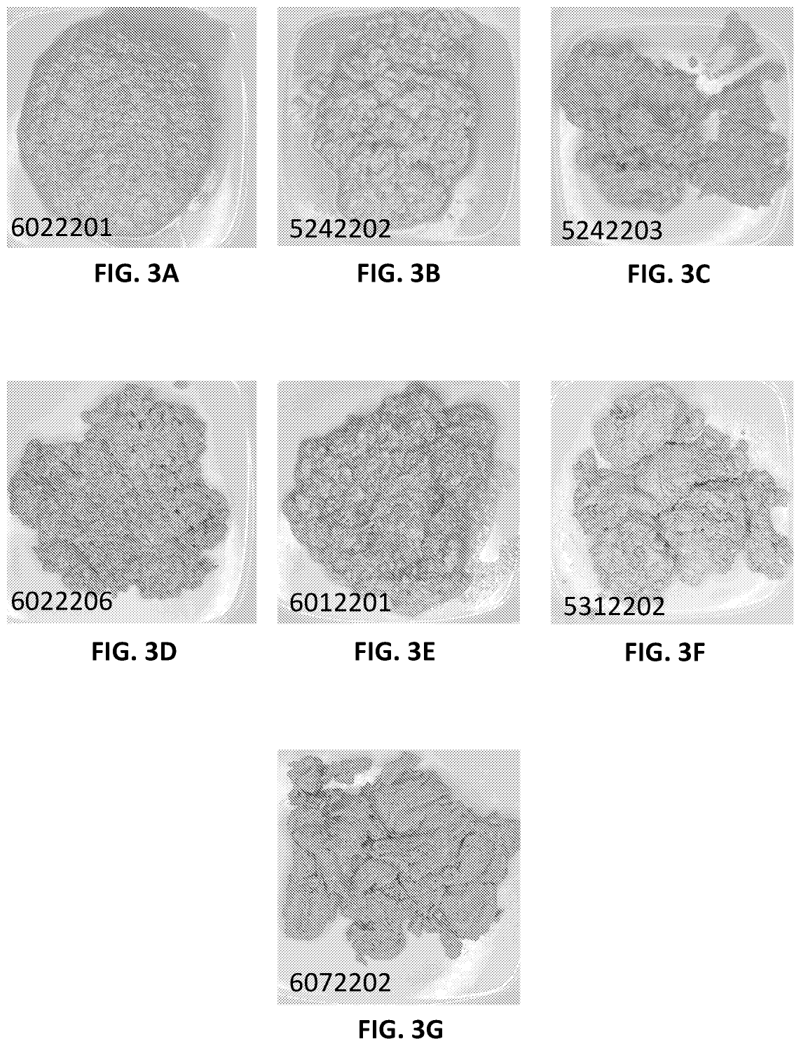

The percentage of the isolated protein, and in particular the percentage of the substantially un-denatured potato protein, as well as the ranges of certain of the additional components may also impact the ability of the composition to mimic traditional egg coagulation or other properties. For example, FIGS. 3A-3G illustrate the effects of a variety of coagulation results for different compositions including un-denatured potato protein (either alone or in combination with a second protein). Table 1, below illustrates some of these examples. Two of these seven examples, (shown in FIGS. 3F and 3G) resulted in coagulation that is comparable or equivalent to that of a traditional egg. Some of these compositions (e.g., FIGS. 3A-3B) failed to coagulate to any appreciable degree and corresponded to either a very low percentage of substantially un-denatured potato protein (e.g., FIG. 3A, which has just 2.08% by weight of substantially un-denatured potato protein) or no chloride (e.g., FIG. 3B, which had 0 NaCl).

TABLE 1
compositions including substantially un-denatured potato protein

| | 5312202 | 5242203 | 5242202 | 6022201 | 6012201 | 6072202 | 6022206 |
|---|---|---|---|---|---|---|---|
| Water | 79.78% | 87.87% | 83.96% | 86.66% | 85.69% | 71.79% | 83.75% |
| Sunflower | 0.00% | 0.00% | 0.00% | 0.00% | 0.00% | 3.02% | 0.00% |
| Lecithin | | | | | | | |
| (approx. | | | | | | | |
| 3%?) | | | | | | | |
| Calcium | 0.00% | 0.00% | 0.00% | 0.00% | 0.00% | 2.15% | 0.00% |
| Carbonate | | | | | | | |
| Gellan Gum - | 0.00% | 0.00% | 0.00% | 0.00% | 0.00% | 0.18% | 0.00% |
| high | | | | | | | |
| Gellan Gum - | 0.00% | 0.00% | 0.00% | 0.00% | 0.00% | 0.54% | 0.00% |
| low | | | | | | | |
| Psyllium | 0.00% | 0.00% | 0.00% | 0.00% | 0.00% | 0.36% | 0.00% |
| Husk | | | | | | | |
| Sodium Pyro | 0.00% | 0.00% | 0.00% | 0.00% | 0.00% | 0.72% | 0.00% |
| Egg Flavor | 0.00% | 0.00% | 0.00% | 0.00% | 0.00% | 1.44% | 0.00% |
| (FS | | | | | | | |
| 021822C) | | | | | | | |
| Pea Blocker | 0.00% | 0.00% | 0.00% | 0.00% | 0.00% | 0.18% | 0.00% |
| Potato | | | | | | 0.18% | |
| Blocker | | | | | | | |
| Salt | 0.80% | 0.88% | 0.00% | 0.87% | 0.86% | 0.72% | 0.25% |
| Wheat | 0.00% | 0.00% | 0.00% | 4.12% | 1.03% | 5.03% | 0.00% |
| protein | | | | | | | |
| Potato | 13.56% | 5.01% | 10.08% | 2.08% | 6.21% | 6.46% | 10.05% |
| Protein | | | | | | | |
| Isolate | | | | | | | |
| Sunflower | 4.99% | 5.27% | 5.04% | 5.33% | 5.27% | 6.46% | 5.03% |
| Oil | | | | | | | |
| Beta | 0.56% | 0.62% | 0.59% | 0.61% | 0.60% | 0.50% | 0.59% |
| Carotene | | | | | | | |
| Titanium | 0.32% | 0.35% | 0.34% | 0.35% | 0.34% | 0.29% | 0.34% |
| Dioxide | | | | | | | |
| Total | 100.00% | 100.00% | 100.00% | 100.00% | 100.00% | 100.00% | 100.00% |

In general, the amount of substantially un-denatured potato protein (and total overall protein) as well as the amount of chloride was found to be critical to allow coagulation similar to a traditional egg. Compositions with too little (or no) substantially un-denatured potato protein, e.g., less than about 5%, or with too little (or no) chloride, e.g., about 0.25% or less, resulted in poor coagulation as compared to a traditional egg.

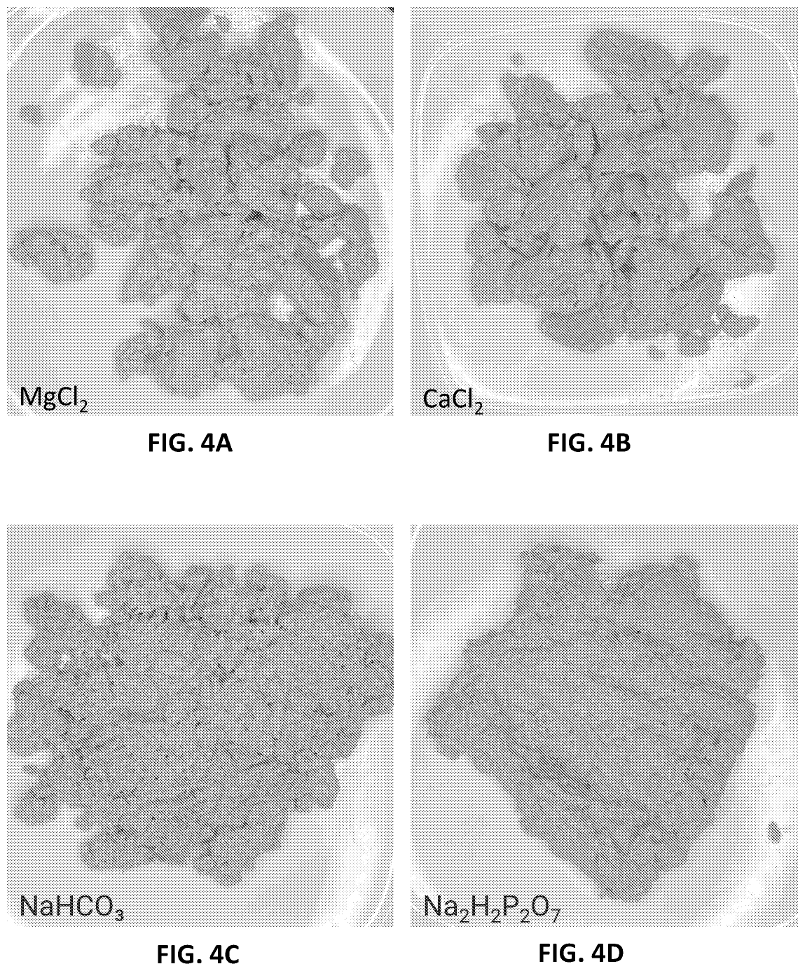

For example, FIGS. 4A-4D illustrate the importance of chloride to the properties of the egg substitute compositions (substantially un-denatured potato protein compositions) described herein. In particular, it was found in experiments similar to those shown in FIGS. 4A-4D that it was not simply the salt (e.g., NaCl), but specifically the chloride (Cl—) that is important for coagulation. For example, when a typical formulation including substantially un-denatured potato protein was used, and all of the sodium and chloride components were removed, (including removing salt, the trisodium pyrophosphate, and the egg flavor, which contains salt) and various sodium or chloride components were added back, only those compositions that included chloride (regardless of the presence of sodium) coagulated similar to a traditional egg. For example, FIGS. 4A-4D illustrate these results. For example, FIG. 4A illustrate a composition including magnesium chloride (a chloride with no sodium present) at 0.73%, FIG. 4B shows a composition of calcium chloride (a chloride with no sodium present) at 0.73%, FIG. 4C shows a composition of sodium bicarbonate (a sodium with no chloride present) at 1.09%, FIG. 4D shows a composition of sodium acid pyrophosphate (a sodium with no chloride present) at 1.45%. The compositions including chloride coagulated, while compositions without chloride, but with sodium did not coagulate similar to a traditional egg. In all of these examples the amount of substantially un-denatured potato protein (approximately 6%) and second protein (pea protein isolate, approximately 5%) was nearly identical. Thus, in general, the egg substitute compositions described herein may coagulate equivalently to a traditional egg.

In addition to coagulation, the substantially un-denatured potato protein compositions described herein (e.g., egg substitute compositions) may also share other properties, including, e.g., emulsification (e.g., useful in the manufacture of egg-based edible products such as mayonnaise) similar or identical to eggs.

For example the substantially un-denatured potato protein egg replacement compositions described herein may share properties such as binding and foaming. In particular the compositions described herein may have properties that permit them to be used for baking, which is novel compared to other egg-replacement compositions previously described.

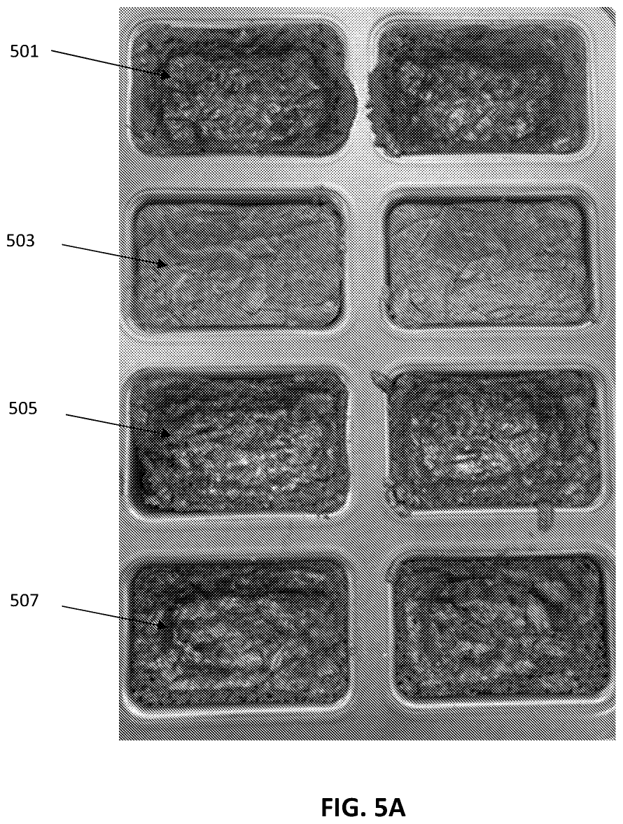

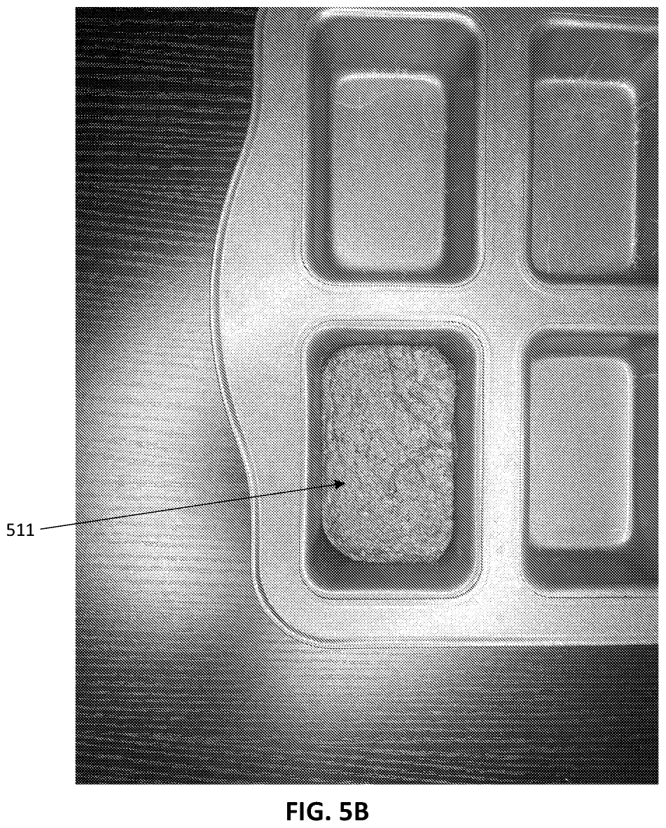

FIGS. 5A and 6 show a comparison of baked food products made with un-denatured potato protein egg replacement compositions described herein, as well as other, commercially available egg replacement products. In FIG. 5A, baked goods (e.g., brownies) were made using different egg substitute products that are commercially available compared against a brownie made with an un-denatured potato protein egg replacement compositions described herein.

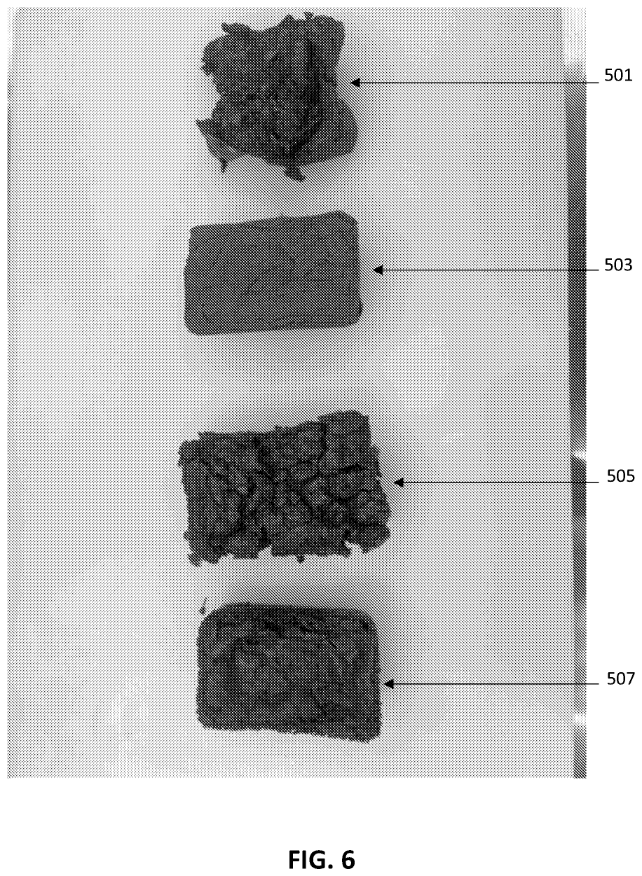

In these experiments, a commercially available brownie mix (Duncan Hines™ Chewy Family Size brownies) were used. Control brownies were made using 2 large eggs, ¼ cup water and ½ cup oil. The control brownie is shown in FIG. 5B, and was used in later experiments (e.g., using a texture analyzer as shown in FIGS. 7A-7B, 8A-8B and 9A-9B). A first commercial egg replacement (a mung bean protein-based egg replacement), Just Egg™ egg replacement brown was made using the same mix, with 110 g of the JustEgg™ composition, equivalent in grams to 2 large eggs, with ¼ cup water and ½ cup oil. The resulting brown is shown in FIG. 5A 501 (top row) and FIG. 6.

Approximately 110 g, equivalent in grams to 2 large eggs, of un-denatured potato protein egg replacement composition (including 13.16% by weight of the substantially non-denatured potato protein isolate, 2.85% by weight of a plant lecithin, 0.82% by weight of a calcium carbonate, 2.19% by weight a pea fiber, 0.55% by weight of the chloride (NaCl), 1.10% by weight of a tetrasodium pyrophosphate, 5.48% by weight of sunflower oil and 2.19% coconut oil) was used to bake the brownie 503 shown in FIG. 5A, 6 and tested using a texture analyzer as shown in FIGS. 7A-7B, 8A-8B and 9A-9B. The un-denatured potato protein egg replacement composition was used with ¼ cup water and ½ cup oil.

A second commercially available egg replacement composition, Ener-G™ Egg Replacer, was also tested and used to bake a brownie 507 Three tsp. of the Ener-G™ Egg Replacer was used with 2 tbsp water (to hydrate it, per instructions) with ¼ cup water and ½ cup oil. As an additional step for Ener-G™ Egg Replacer preparation, the 3 tsp of Ener-G Egg Replacer was mixed with 4 tbsp of warm water.

Finally a third commercially available egg replacement composition, Simply Eggless™ egg replacer was used with the same mix (including ¼ water and ½ cup oil) to produce a brownie 505 shown in FIGS. 5A and 6 and examined with the texture analyzer as shown in FIGS. 7A-7B, 8A-8B and 9A-9B.

For all of these brownies, the brownies were prepared as described on the mix instructions. For example, the oven, was preheated to 350 degrees F., and the bottom of the metal pan was greased with butter. The brownie mix was combined with the respective egg substitute, water and oil in a large bowl and stirred until well blended (about 50 strokes). The mixes were then spread into the greased pans and baked immediately at 350 degrees F. for the same lengths of time.

It can be seen in FIGS. 5A and 6 that the resulting brownies made with the commercially available egg substitutes 501, 505, 507 are sunken in the well of the pan, the color is dark (indicating an adverse amount of moisture retained by the brownie), and as shown in FIG. 6, the resulting brownies also failed to hold their shape (crumbling) upon removal from the pan. In contrast the brownie prepared using the un-denatured potato protein egg replacement composition as described herein rose in the well of the pan and had an even color and shine. The observable characteristics of the brownie 503 are most similar to a brownie comprising a traditional egg 511 (FIG. 5B). These results highlight significant and unexpected differences in the food products comprising commercially available egg substitutes as compared to a traditional egg and the un-denatured potato protein egg replacement compositions described herein. The brownie made with the un-denatured potato protein egg replacement composition 503 formed in a manner expected and associated with a brownie made using traditional eggs.

FIG. 6 shows brownies 501, 503, 505, 507 after being removed from the wells of the pan. As discussed above, the brownie made with the un-denatured potato protein egg replacement composition retained a uniform shape and color one would expect from a brownie comprising traditional eggs (FIG. 6). Brownies 501, 505, 507 were substantially deformed simply by removing them from the pan structure. These brownies (and particular 501 and 505) fell apart without a scaffolding to support the brownie structure.

The resulting baked goods were examined on a texture analyzer, to compare brownies made with traditional eggs to the un-denatured potato protein egg replacement compositions described herein as well as with other commercially available egg substitutes. The baked goods (e.g., brownies) made with the un-denatured potato protein egg replacement compositions described herein were most similar to the baked goods made with traditional eggs. In contrast other commercially available egg substitutes were significantly different in textural properties (e.g., incisal shearing, relaxation and molar compression).

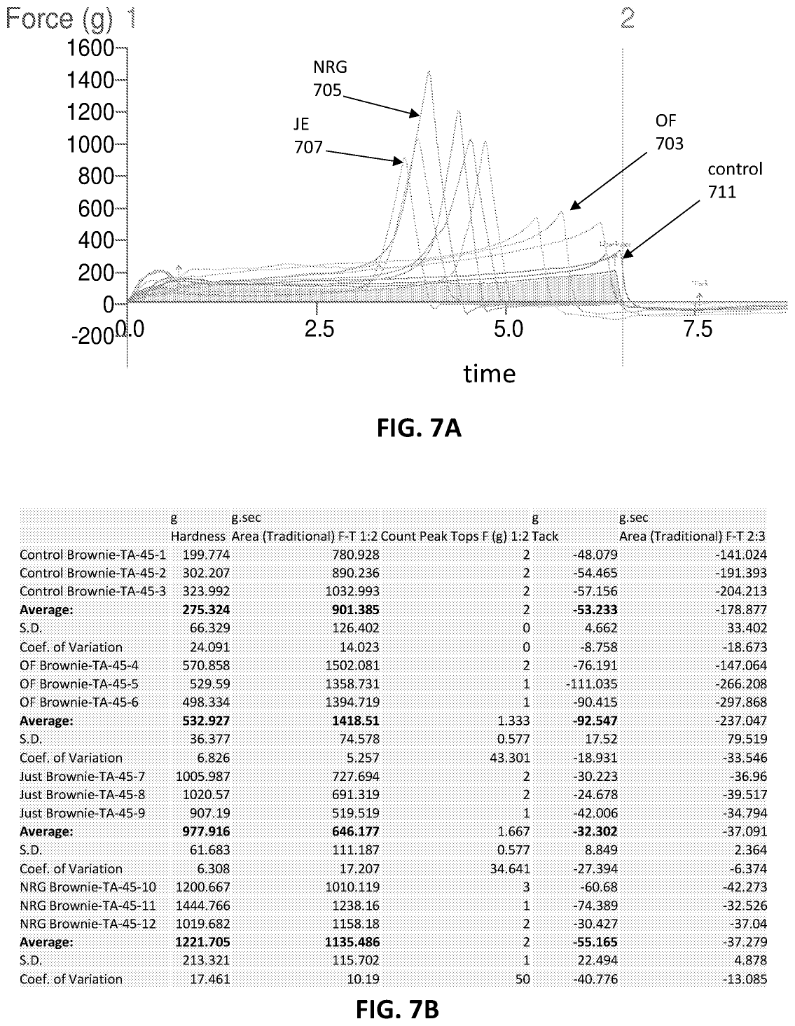

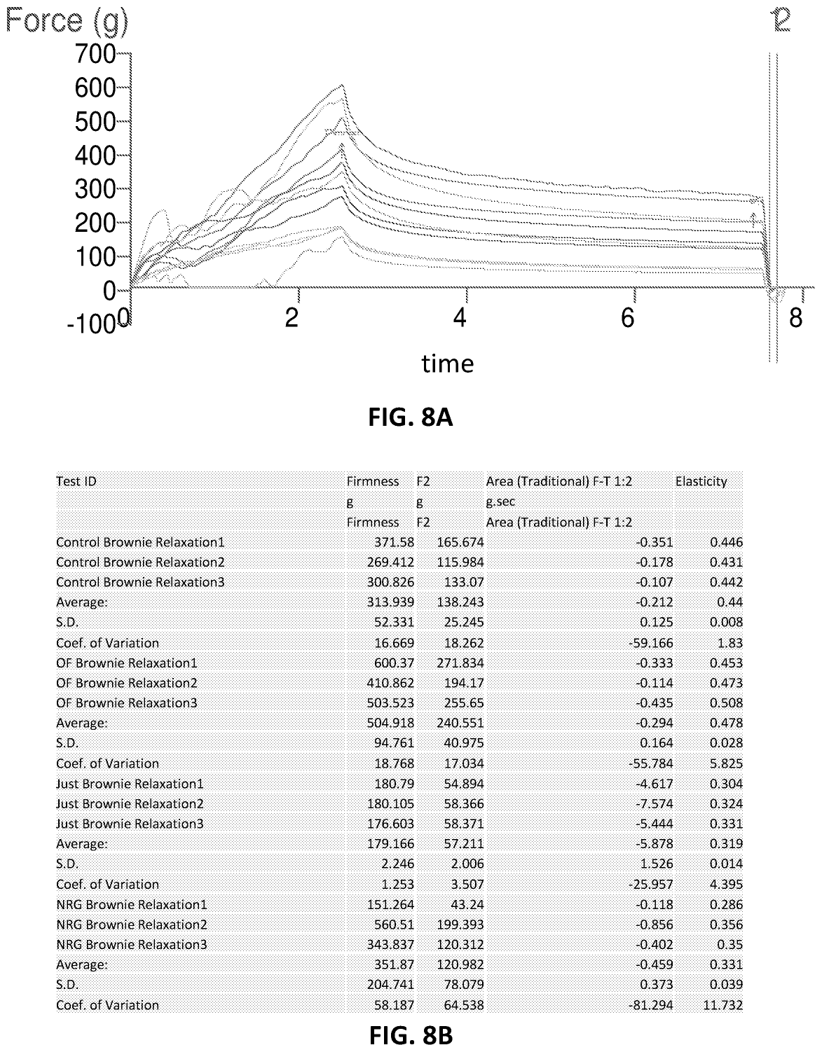

For example, FIG. 7A shows a graph comparing force measurements made with a texture analyzer configured to replicate incisal shearing. Triplicates of each of the control, un-denatured potato protein egg replacement composition brownie, and two of the commercially available egg substitutes (Just Egg™ egg replacer and Ener-G™ egg replacer) were measured and compared. As shown in FIG. 7A the un-denatured potato protein egg replacement composition brownie 703 demonstrated shear properties (force over time) that were very similar to those of the control brownie. In contrast the shear properties of the commercially available egg substitute brownies 705, 707 were significantly different from the control. FIG. 7B is a table showing quantification data, corresponding to the graphical data shown in FIG. 7A. Similar results were seen for relaxation; the un-denatured potato protein egg replacement composition brownie was significantly closer to the control brownie as compared to the egg substitute brownies, as shown in FIGS. 8A and 8B. Similar results were also seen for molar compression, as shown in FIGS. 9A and 9B.

In general, the un-denatured potato protein egg replacement compositions described herein, may be directly used as a plant-based egg substitute. For example, a plant-based egg substitute composition described herein may be combined with one or more dry ingredients prior to the inclusion of one or more liquids.

The un-denatured potato protein egg replacement compositions described herein may have binding characteristics similar or identical to a traditional egg. For example, components of any composition described herein may provide improved, same, or substantially similar chemical activity and capabilities to one or more molecules found in a traditional egg. Some examples, of proteins found in a traditional egg (e.g., Ovalbumin, Ovotransferin, Ovomucoid, Ovomucin, Lysozyme, Ovoinhibitor, Ovoglycoprotein, Ovoflavoprotein, Ovomacroglobulin, and Avidin) their function may be related to structural development of the egg during use (e.g., cooking). Any composition described herein may comprise plant-based proteins based on their activity, capabilities, and/or structures formed by protein binding with one or more other components of any composition described herein.

As mentioned above, the extent to which one or more of the proteins included in the compositions described herein are non-denatured may relate to the extraction and isolation of the non-denatured protein. Processes of extracting protein isolates may include one or more steps to prevent the unfolding or other structural change of the natural protein. Maintaining the natural protein structure may confer structural improvement to the matrices formed by the proteins in the plant-based egg substitute composition described herein. The non-denatured proteins may bind and form structural elements (e.g., matrices) when the composition is combined with a liquid. The matrices can be irreversible and promote the observable characteristics of the egg-substitute product after heat is applied. The observable characteristic of the egg-substitute product may relate to the amount of liquid and/or gas (e.g., air) retained within the matrices.

In some examples, proteins included in a plant-based egg substitute composition, as described herein may promote coagulation or gelation of the egg-substitute product at different temperatures or ranges of temperatures. For example, a first protein (e.g., non-denatured plant-based protein isolate) may bind with one or more other components of the composition forming a matrix when heat is applied at a first temperature (or within a first temperature range). The composition may coagulate (e.g., gel) at a gradual and/or progressive rate.

In some examples, a plant-based egg substitute composition may coagulate (e.g., gel) at a temperature of 30° C., 35° C., 40° C., 45° C., 50° C., 55° C., 60° C., 65° C., 70° C., 75° C., 80° C. or more or any temperature therebetween. In some examples, a first protein matrices may coagulate (e.g., gel) at a temperature of 30° C., 35° C., 40° C., 45° C., 50° C., 55° C., 60° C., 65° C., 70° C., 75° C., 80° C. or more or any temperature therebetween. Additional protein matrices may coagulate (e.g., gel) at a temperature of 30° C., 35° C., 40° C., 45° C., 50° C., 55° C., 60° C., 65° C., 70° C., 75° C., 80° C. or more or any temperature therebetween, where a temperature of the coagulation of the first protein matrices is less than a temperature of coagulation of additional protein matrices.

Plant-based proteins may include proteins and/or protein isolates derived from plants. An example of a non-denatured plant-based protein may be a non-denatured potato protein isolate. In some examples, proteins described herein may be derived from soy, wheat, pea, rice, canola, potato or other non-animal sources. In some examples, proteins may be in a dry form (e.g., a powder) after being extracted and/or isolated from the plant-based source.

In some examples, any composition described herein may comprise one or more hydrocolloid agents. Non-limiting examples of hydrocolloids may include gelatin, casein, egg white protein, soy protein, agar, carrageenans, alginate, xanthan gum, dextran, methylcellulose, ethylcellulose, carboxymethylcellulose, propylene glycol alginate, modified starches, guar gum, pectin, konjac, Arabic gum, karaya gum, tragacanth gum.

In some examples, any composition described herein may comprise one or more fats. Non-limiting examples of fats may include plant-based oils such as sunflower oil, coconut oil, avocado oil, olive oil, sesame oil, peanut oil, bran oil, grapeseed oil, etc.

In some examples, any composition described herein may comprise one or more salts. In some examples, one or more salts may contribute to gelation (e.g., coagulation) of any composition described herein. For example, one or more salts may impact protein binding activity, pH, component binding characteristics, etc. Non-limiting examples of salts may include table salt (e.g., sodium chloride), cooking salt, curing salt, dead Sea salt, flake salt, Halite, Himalayan salt, Black salt, kitchen salt, Kosher salt, Moshio salt, Murray River, salt flakes, Namibian salt pearls, blue salt, pickling salt, sea salt, smoked salt, etc. In particular, chloride salts may be used.

In some examples, any composition described herein may comprise one or more lecithin agents. For example, any composition described herein may comprise a plant-based lecithin (e.g., soy lecithin). In some examples, lecithin may act as an emulsifier for any of the compositions described herein, when combined with a liquid (e.g., water).

In some examples, any composition described herein may comprise one or more leavening agents. Leavening agents may include agents from natural sources and/or agents from chemical sources.

In some examples, any composition described herein may comprise one or more flavoring agents configured to flavor any composition described herein. In some examples, one or more flavoring agents may modify flavor of a food product comprising any composition described herein.

In some examples, any composition described herein may comprise one or more coloring agents. Coloring agents may be configured to provide color and/or shine to any composition described herein and/or any food product comprising any composition described herein. In some examples, any composition described herein may comprise one or more coloring agents configured to color the composition the same as a traditional egg. For example, any composition described herein may comprise one or more coloring agents having the same or similar color to a traditional egg yolk. In some examples, non-coloring agents may be configured to influence and observable color, shine, or appearance to any composition described herein. For example, proteins may influence a brown-like color when any composition described herein is prepared as a food product (e.g., pan-frying any composition described herein). Non-limiting examples of coloring agents may include beta carotene, titanium dioxide, annatto extract, beet juice, black/purple carrot, blue fruit juice color, blue shade vegetable juice colors, blue spirulina extract, calcium carbonate, caramel color, elderberry, fruit juice, grape juice, hibiscus fruit, paprika, purple carmine, purple sweet potato, red cabbage, red carmine, red radish, riboflavin, turmeric (e.g., curcumin), etc.

In some examples, an impact on sensory perception of a user may comprise an extent which any composition described herein gels (e.g., coagulates). Gelation may refer to the phase change of the composition in the presence of the liquid (e.g., water). One or more components of any composition described herein may be configured to induce, increase, or modulate gelation (e.g., coagulation) of the composition mixture in a liquid. The gelation may be modified based on the ratio of one or more components of a composition described herein. In some examples, increased gelation may be associated with a thicker resultant egg-substitute product. In some examples, proteins within the composition may coagulate in the presence of salt (e.g., sodium chloride). In some examples, protein-protein interaction may include one or more proteins of any composition described herein binding with one or more other proteins in the composition resulting in scaffolding (e.g., matrices). In some examples, salt within a composition described here may influence protein aggregation and gelation. In some examples, one or more hydrocolloid agents may be configured to induce and/or promote gelation.

In some examples, gelation (e.g., coagulation) of any composition described herein may occur at or below room temperature. For example, a plant-based egg substitute composition described herein may be combined with a liquid and one or more of the composition components can begin binding with one another at or below room temperature to form structural elements (e.g., matrices) resulting in the gelation of the composition-water mixture.

In some examples, gelation at room temperature may be induced by agitation. For example, any composition described herein may be combined with a liquid and agitated (e.g., whipped) causing one or more of the composition components to interact, aggregate, coagulate forming a gel and/or foam. For example, the agitation may induce the formation of a meringue when enough gas (e.g., air) are incorporated into the structural elements formed by the composition components (e.g., non-denatured proteins).

In some examples, gelation (e.g., coagulation) of any composition described herein may be heat induced. For example, a plant-based egg substitute composition described herein may be combined with a liquid. Heat may be applied to the mixture resulting in coagulation or gelation of the mixture. The mixture may coagulate in a manner substantially similar to the gelation and/or coagulation of an egg after heat is applied. In some examples, gelation may be induced and/or modulated by heat. Any composition described herein may be mixed with a liquid then subjected to heating (e.g., via a cooking process). The heat applied may be sufficient to influence the arrangement and/or interaction of one or more components of the composition to induce the formation of structural elements comprising a plurality of composition components. In some examples, any composition described herein may include one or more components configured to act as a gelling agent (e.g., hydrocolloids and/or proteins). In some examples, gelation of any composition described herein may relate to the one or more gelling agents; and/or composition conditions such as temperature, ion concentration, pH, etc. In some examples, proteins described herein are sufficiently non-denatured prior to the heating of the composition and/or mixture of the composition with a liquid. In some examples, application of heat to the mixture of the composition and liquid may cause the proteins to denature and/or start to denature. In some examples, denaturation of the proteins only occurs after a plant-based egg substitute composition is subjected to heat.

In some examples, any of the compositions described herein may provide a food product with the same attributes (e.g., characteristics) as a traditional egg. For example, any composition herein may be prepared in a similar manner to a traditional egg and the resulting food product may have the same, substantially similar and/or improved effect on sensory perceptions of the user. In some examples, similarities (e.g., similar sensory perceptions) between any composition described herein and a traditional egg may be 60%, 65%, 75%, 80%, 85%, 90%, 95%, 100% similar. In some examples, a user may prefer one or more sensory perceptions of a food product comprising any composition described herein compared to a traditional egg.

In some examples, an impact on sensory perception of a user may comprise a texture of a food product comprising any composition described herein. For example, texture may relate to an external texture, internal texture, texture of any food product comprising any composition herein as an egg substitute, and/or a combination thereof. Texture may refer to observable characteristics when a user cuts, smashes, blends, mixes, bites, chews, swallows, touches, and/or any combination thereof. In some examples, texture may relate to an observable mouthfeel of a food product comprising any composition described herein. For example, the mouthfeel of a food product comprising any composition described herein may be improved, the same, or substantially similar to a mouthfeel of a traditional egg.

In some examples, an impact on sensory perception of a user may comprise a flavor of a food product comprising any composition described herein. For example, a food product comprising any composition described herein may have an improved, same, and/or substantially similar flavor to an equivalent food product comprising a traditional egg.

In some examples, an impact on sensory perception of a user may comprise a color of a food product comprising any composition described herein. For example, a food product comprising any composition described herein may have an improved, same, and/or substantially similar color to an equivalent food product comprising a traditional egg. In some examples, preparation of any composition herein as a food product may comprise improved, same, and/or substantially similar color change compared to a traditional egg. For example, as any composition herein is prepared in a pan as an egg-substitute scramble, a color of the composition may include color changes from a first color to a brown color where extended and/or high heat is applied.

The color, texture, and observable gelation of the food product made with the un-denatured potato protein egg replacement compositions described herein may be improved, the same and/or substantially similar to that of a scrambled traditional egg. For example, the coloring agents of this example are configured to replicate the yellow-orange color of an egg as the yolk would have broken and become dispersed throughout the scramble. The chunks of the egg-substitute composition shown, for example, in FIG. 1 are of the same general size and shape of a scrambled traditional egg, and the overall appearance of the food product may not be differentiable from any example of a scrambled traditional egg.

In some examples, an impact on sensory perception of a user may comprise a scent of a food product comprising any composition described herein. For example, a food product comprising any composition described herein may have an improved, same, and/or substantially similar flavor to an equivalent food product comprising a traditional egg.

In some examples, any composition described herein may be configured to replace an egg as an element of preparing a food product. For example, any composition herein may be configured to replace an egg in preparation of baked goods, sauces, soups, pastries, deserts, doughs, noodles, dressings, beverages, etc.

### Coagulation and Texture

In general, the compositions and methods described herein may provide an egg substitute that has the texture and properties that more closely approximate a traditional egg than currently available egg substitutes. These properties may the coagulation of the composition, for example when preparing an emulsion or gel from the composition, and/or when heating the composition (e.g., cooking). In addition, the compositions described herein provide may match or mimic the mechanical properties of traditional eggs, as confirmed by a texture analyzer. These properties may include firmness, toughness, resilience and springiness.

For example, egg substitute compositions having various concentrations (e.g., between 5% to 15% by weight) of a substantially non-denatured potato protein isolate (e.g., patatin) where combined with various combinations of fats (e.g., between 1% to 25% by weight), with or without chloride at various concentrations (e.g., between 0.3% to 3% by weight), and with or without calcium carbonate (e.g., between 1% to 3% by weight). The physical characteristics of these compositions were examined with a TA.XTplus Texture Analyzer using a TA-04040SQFL-G Parallel Plate Fixture to measure the firmness, toughness, resilience, and springiness of the egg substitute. These values were also compared to that of real eggs (control), as well as other commercially available egg substitutes. The TA040SQFL-G fixture includes a grid pattern cut into the faces to grab the sample and prevent it from leaking out excessively during compression. The upper platen is calibrated against the lower platen and tests are conducted to a constant gap or to a constant strain.

For example, the texture analyzer may be used to determine firmness as a textural property, which is the same property spectrum as hardness/softness. A soft product is one that displays a slight resistance to deformation, a firm product describes one that is moderately resistant to deformation and hardness describes a product which displays substantial resistance to deformation. Toughness is another textural property that may be assessed, as the total positive area under the curve when sampling the response to applied force by the texture analyzer. This measurement records the total ‘work’ involved in performing this test. A higher area value indicates a higher amount of energy involved in performing the test and subsequently is translated as a tougher sample to test. Resilience is a measurement of how the sample recovers from deformation both in terms of speed and forces derived. It may be taken as the ratio of areas from the first probe reversal point to the crossing of the x-axis and the area produced from the first compression cycle. Springiness refers to the rate at which a deformed material goes back to its undeformed condition after deforming force is removed. It is a measurement of elastic recovery. It is commonly the textural property possessed by baked goods such as cake or bread but also possessed by novel confectionery products and pharmaceutical materials (e.g. cosmetic sponges).

Tests for different possible egg substitute compositions and cook times were conducted in quadruplicates (n=4). The test speed was 5 mm/second. The upper platen was positioned at precisely 40 mm over the bottom platen at the commencement of the test and the test was conducted with a maximum of 65% strain. The post-test speed was set to 5 mm/second so the energy and height recovery could be contrasted with the downstroke behavior. The rheological quantity associated with deformation is strain, a measure of the relative displacement between the particles of a material. Strain is the change in dimensions of a test specimen caused by the application of a stress. In simple uniaxial compression (the type of test for which the texture analyzer is most frequently used by food technologists), strain is the change in length per unit length (measured in millimeters) and is therefore dimensionless.

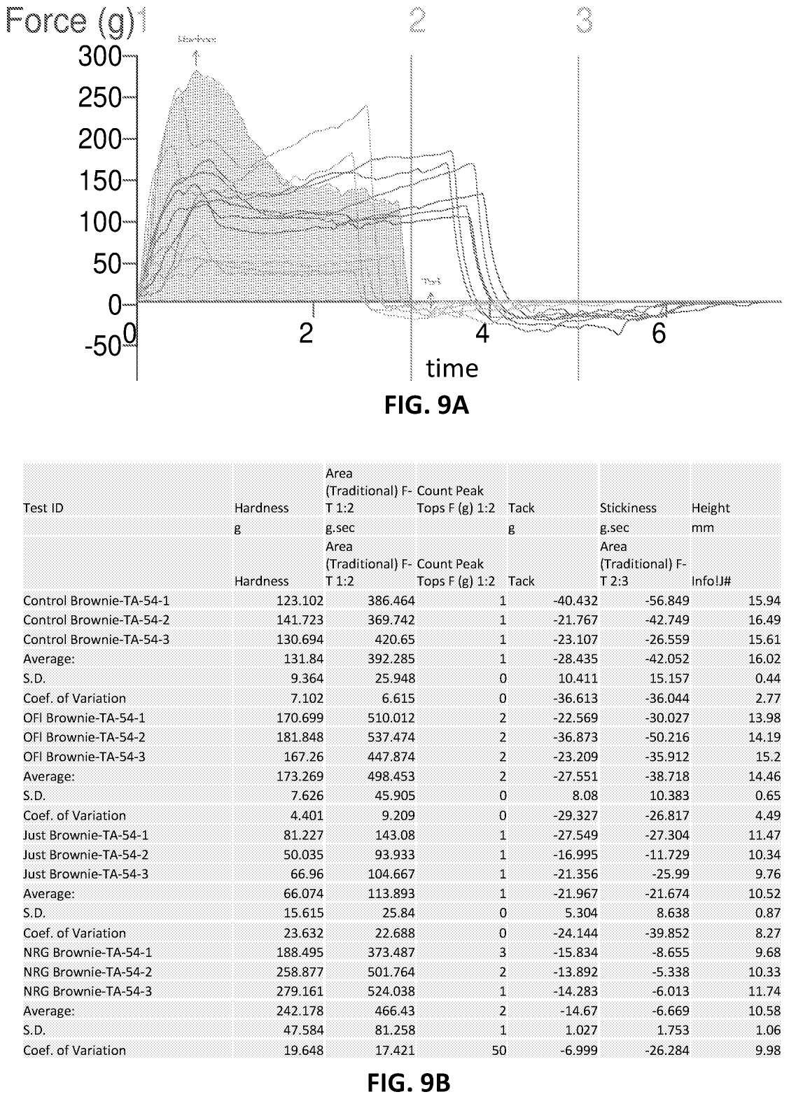

As illustrated in FIGS. 10A-10D, the critical textural and chemical properties, including textural properties, may be empirically compared for various compositions, particularly in comparison with traditional eggs. For example, FIG. 10A graphically illustrates the difference in firmness between control (traditional eggs) a first example of an egg substitute composition as described herein, and variations of this composition in which key components are varied or omitted (such as denaturation state of the potato protein, chloride, calcium carbonate, fat type, etc.). The egg substitute compositions described herein can also be compared to commercial egg substitutes, such as Just Egg™ can be compared. For example, a baseline for traditional eggs may be compared to putative compositions of egg substitutes using the same sample handling, cooking and testing procedures. Equivalent amounts (e.g., 55 g) of egg substitute compositions were compared to Lucerene Large Grade A A, Cage Free Eggs (55 g). The Just Egg™ sample preparation and cooking procedure was in accordance with the instructions on the package for the equivalent of a single egg. All eggs and egg substitutes were cooked in non-stick pan with approx. ½ tsp safflower oil over medium heat (approx. 250 degrees) to a minimum internal temperature of 160 degrees and not to exceed a maximum internal temperature of 170 degrees. Similar testing was performed on egg patties as scrambled egg form factors. Commercially available egg substitute patties were prepared in accordance with the instructions on the packaging.

Table 2, below illustrates examples of the test compositions for the egg substitutes that were examined.

TABLE 2
Test egg substitute compositions

| | Sample 1 | Sample 2 | Sample 3 | Sample 4 | Sample 5 |
|---|---|---|---|---|---|
| Water | 72.77% | 74.49% | 75.31% | 72.85% | 72.77% |
| Sunflower Lecithin | 1.09% | 1.12% | 1.13% | | 1.09% |
| (approx. 3%?) | | | | | |
| Calcium Carbonate | 0.55% | 0.56% | 0.57% | 1.41% | 0.55% |
| Gellan Gum - high | | | | 0.21% | |
| Gellan Gum - low | | 0.35% | | 0.21% | |
| Xanthan | | | | 0.21% | |
| Tetrasodium pyrophosphate | 0.55% | 0.56% | | 0.19% | 0.55% |
| Egg Flavor (no gum Arabic) | 1.09% | 1.12% | | 1.88% | 1.09% |
| Onion Granules | | | | 0.14% | |
| Garlic Granules | | | | 0.14% | |
| Pea Blocker | 0.14% | 0.14% | | | 0.14% |
| Potato Blocker | 0.14% | 0.14% | | 0.23% | 0.14% |
| Pea Fiber | | | | 0.47% | |
| Salt | 0.55% | 0.56% | | 0.70% | 0.55% |
| Pea Isolate | | 3.14% | | 0.00% | |
| Potato Protein Isolate | 13.51% | 7.98% | 13.99% | 11.98% | 13.51% |
| (undenatured) | | | | | |
| Sunflower Oil | 6.51% | 6.67% | 6.74% | 8.46% | 3.23% |
| Coconut Oil | 2.19% | 2.24% | 2.27% | | 5.47% |
| Titanium Dioxide | 0.23% | 0.24% | 0.00% | 0.23% | 0.23% |
| Turmeric (yellow) | 0.52% | 0.53% | 0.00% | 0.52% | 0.52% |
| Beta Carotene | 0.16% | 0.16% | 0.00% | 0.16% | 0.16% |
| Batch Total | 100.00% | 100.00% | 100.00% | 100.00% | 100.00% |

The egg substitute compositions shown in Table 2, and variations of them, were examined using the texture analyzer and as described above. In Table 2, cells without values did not have any appreciable amount of the corresponding component. FIGS. 10A-10D illustrate representative results. For example, FIG. 10A shows a comparison of the relative firmness of traditional eggs (control) to sample 1, sample 2, a variant of sample 1 in which the potato protein (patatin) was heat-denatured, and sample 3 (without chloride). FIG. 10A also shows the relative firmness of a commercially available egg replacement product (JustEgg™). In this example, the result show that samples 1 and 2 had firmness that was comparable with traditional eggs. Note that sample 5 was nearly identical to Sample 1 (not shown in FIG. 10A). Variations of the egg substitute using denatured potato protein (denatured patatin) were significantly less firm, as were variations without chloride, and/or without tetrasodium pyrophosphate (Sample 3). Further, the commercially available egg replacement composition had a stiffness that was significantly different. FIG. 10B shows examples of the raw traces from the texture analyzer output for firmness.

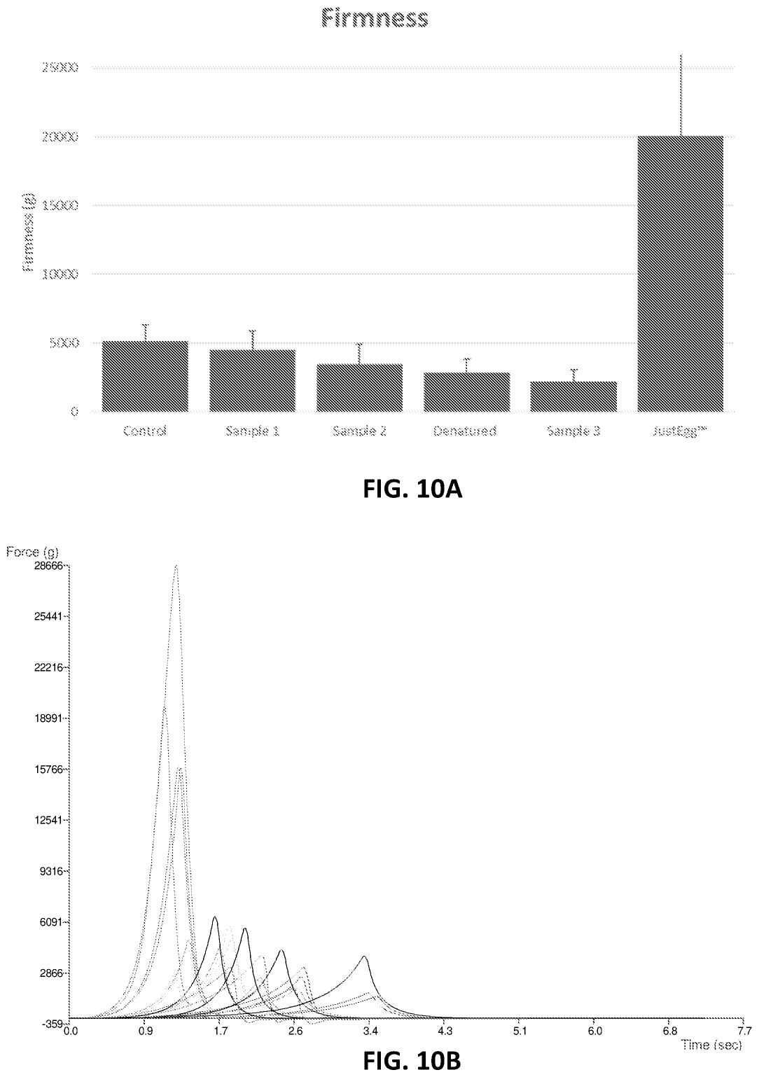

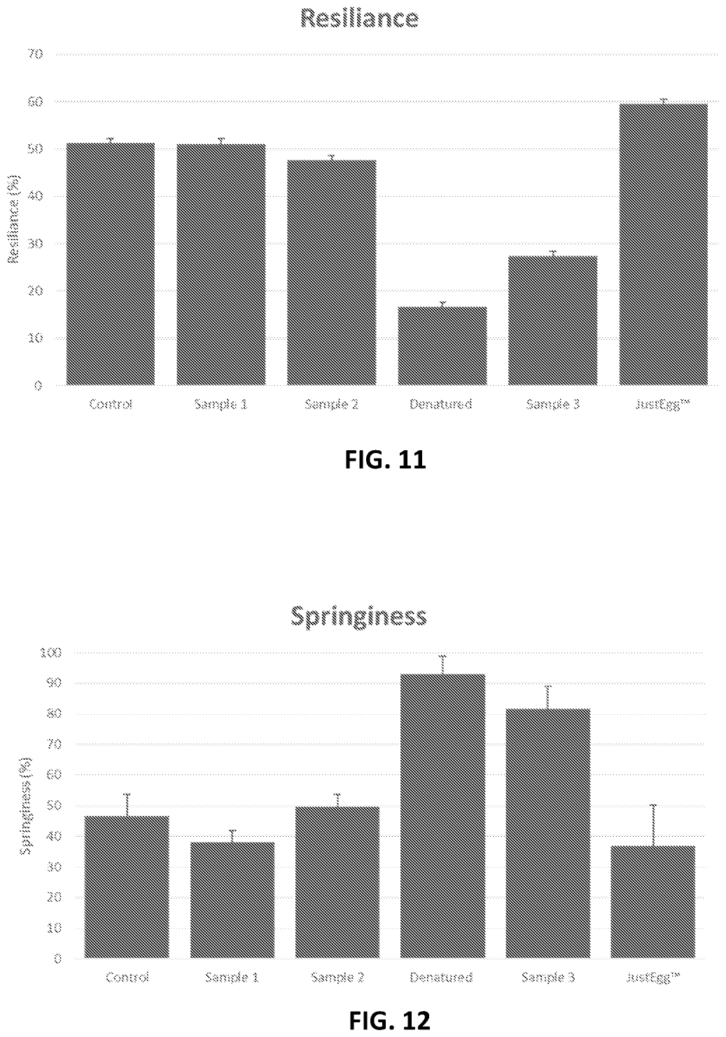

Similar results were seen with other textural properties, including resilience (FIG. 11) and springiness (FIG. 12), and toughness (not shown). For example, as shown in FIG. 11, the resilience of samples 1, 2 and 5 were approximately equivalent to traditional egg, while variations that used denatured patatin, or that did not include chloride and/or calcium carbonate (e.g., without buffering pH, Sample 3) did not. In FIG. 12, the springiness of samples 1 and 2 was approximately the same as traditional egg, while those that used denatured patatin or that did not include chloride and/or tetrasodium pyrophosphate (e.g., Sample 3) did not.

The texture analyzer data may be used to refine the upper and lower limits on the ranges of the various components that may result in egg replacement compositions in order to best match the chemical and textural properties of the putative egg replacement material to traditional egg. The textural data described herein was consistent with taste experiments, in which tasters reported a similar taste and texture to a traditional egg in the samples that approximated the firmness, resilience, springiness, and toughness of traditional egg.

Generically, a texture analyzer may physically deform a test sample in a controlled manner and measure its response. The characteristics of the force response are as a result of the sample's mechanical properties, which correlate to specific sensory texture attributes. A texture analyzer applies this principle by performing the procedure automatically and indicating the results visually on a digital numerical display, or screen.

The food product (egg replacement compositions) described herein may therefore be quantitatively examined for sensory attributes such as firmness, resilience, toughness and springiness and the results may be quantified using a texture analyzer, such as the TA.XT Plus texture analyzer (e.g., Stable Micro Systems) using a Parallel Plate Fixture and/or a load cell (e.g., a 50 kg load cell). The egg substitute may be directly examined, or may be examined as a cooked product, such as an egg scramble and/or egg patty, or may be examined as part of a baked good (as described above). For example, when prepared as a cooked egg patty, the traditional egg or egg substitute sample may be prepared in a non-stick pan by heating to a minimum internal temperature of 160 degrees and not to exceed a maximum internal temperature of 170 degrees. In some cases traditional eggs (control) were mixed, e.g., combining egg yolk and egg white, prior to cooking. In some examples egg whites alone were examined (with minimal difference in textural properties. Baked food products were tested by texture analyzer using following baking per standard recipe instructions.

The cooked egg substitute sample or food product (e.g. baked good) including the egg substitute sample may be examined. In some examples the material was placed between the parallel plate fixture. Compression may be applied as the plate travels downward, e.g., at | mm/see, squeezing the sample until a target range is reached (e.g., 30% strain for a baked good). The force with which the sample resists compression is a measure of the “firmness” of the baked good. Resilience, toughness and/or springiness may likewise be tested and/or derived, as described above.

Repeated testes showed that the egg substitute compositions described herein including between 3% to 20% by weight of a substantially non-denatured potato protein isolate (e.g., patatin, including non-denatured patatin, patatin denatured by less than 35%), between about 1% to 25% by weight of a fat (in some examples, preferably including MCT as described herein), and between about 0.3% to 3% by weight of chloride, in which the egg substitute (prior to cooking) was adjusted to have a pH of between about 7.1 to 7.8 (and preferably between about 7.2 to 7.8) had quantified texture properties, such as firmness, toughness, resilience and springiness of within about 35% that of traditional egg.

Experiments performed to modify one or more of these components illustrated that the non-denatured status of the protein, the percent by weight of salt and the pH are critical to providing an egg substituted as described herein, in which the textural properties and flavor are comparable to traditional egg. In particular, outside of these ranges, the resulting composition was not comparable to traditional egg. For example, the use of potato protein (e.g. patatin) in which more than 35% of the protein (when included between 5%-20% of the sample) is denatured resulted in a sample that failed to coagulate and had textural properties, including firmness and resilience, of about half that of traditional egg. Samples having less than 0.3% chloride (e.g. from salt) also failed to coagulate and had textural properties, including firmness and resilience, of about a third that of traditional egg. Similarly, outside of the pH range of about 7.1 to 7.8, samples (e.g., those that did not include a pH buffer such as calcium carbonate, between 0.01%-3.5% by weight, tetrasodium between about 0.7%-1.3% by weight, and/or sodium acid pyrophosphate between 0.5 to 2%) had textural properties including firmness and resilience that were outside of the textural properties of a similarly prepared traditional egg by more than 35%. In general, the optimal range of pH appears to be between 7.2 and 7.8 (and in some cases between 7.3 and 7.7). The use of additional materials, such as flavorants, colors, additional protein(s), etc. did not significantly alter the textural properties, at least over the ranges described herein.

Thus, described herein are egg substitute compositions of non-denatured protein (e.g., potato protein, including patatin) wherein the egg substitute, when cooked (alone) to an internal temperature of between 160-170 degrees, has a firmness of within about 35% of a traditional egg (e.g., approximately 5.1 kg when measured as described herein, e.g., under a maximum of 65% compression strain). In some examples the egg substitute compositions has a firmness of between about 6800 g and 3200 g; between about 6700 g and 3300 g, between about 6600 g and 3400 g, between about 6500 g and 3500 g between about 6400 g and about 3600 g, between about 6300 g and about 3700 g, between about 6200 g and about 3800 g, between about 6100 g and about 3900 g, between about 6000 g and about 4000 g, etc.

As described above, the compositions described herein may generally adjust the pH to be slightly alkali, e.g., between 7.1 and 7.8 (e.g., between 7.1 and 7.7 or 7.1 and 7.6). This may be achieved by adding one or more food-safe pH buffers, and in particular calcium carbonate and/or tetrasodium pyrophosphate. As shown in FIGS. 10A, 11 and 12, when the pH of the composition was not controlled, e.g., by omitting calcium carbonate and tetrasodium pyrophosphate, the resulting composition (which had a pH of about 6.6), failed to coagulate properly and had a texture, as measured by texture analyzer, that was significantly different from traditional eggs. Both the taste and feel (e.g., experienced texture) was also significantly off in both the egg (e.g., scramble or egg cake) and baked food products.

The compositions described herein were titrated to determine an optimal pH, by adding one or more of calcium carbonate, tetrasodium pyrophosphate and sodium acid pyrophosphate, and tested as described above. Preparations based on both Sample 1 (described above) and on Sample 5, enriched for medium chain fatty acids, such as and capric acid (decanoic acid, C10), lauric acid (C12), caprylic acid (octanoic acid, C8) were examined at increasingly higher pH levels. When formulated as shown in Table 2 without either calcium carbonate of tetrasodium pyrophosphate, the resulting compositions had a pH or 6.5 and did not approximate the textural properties of traditional egg, as measured by texture analyzer, described above. The firmness (g) was typically less than 2300 g as compared to egg (approximately 5100 g) for both compositions. Similar deficiencies were seen with resilience and springiness. The pH was then adjusted by adding either or both calcium carbonate and tetrasodium pyrophosphate. For example, the addition of 0.55% calcium carbonate to the base composition of Sample 1 or Sample 2 raised the pH from 6.5 to 6.7; at this pH, these compositions (e.g., see, e.g., sample 3) also had a significantly different firmness, resilience and springiness, as shown in FIGS. 10A, 11 and 12. When tetrasodium pyrophosphate was added in increasing increments to raise the pH to 7.5 (to a final concentration of tetrasodium pyrophosphate 0.55%), e.g., within the mildly alkaline level, the results approximated a traditional egg almost exactly. This general trend was found in nearly all of the compositions tested, some of which (e.g., those without pH buffering but with high concentration of non-denatured potato protein isolate) had an initial, unbuffered pH as low as 6.1. In every case, incrementally increasing the amount of tetrasodium pyrophosphate (and optionally calcium carbonate) to increase the pH by 0.1-0.2 increments showed an almost linear increase in firmness approaching that of a traditional egg at between about pH 7.1, and plateauing until after pH 7.8. Similar results were seen with the resilience, toughness and springiness. This range of slightly alkaline pH compositions also had better experienced texture and flavor, as assayed by a panel of judges. In any of the compositions described herein tetrasodium pyrophosphate may be used in place of sodium acid pyrophosphate and vice-versa.

### Medium Chain Fatty Acids

The compositions described herein in which the fat (e.g., oil) is enriched for medium-chain fatty acids (e.g., medium chain triglycerides, MCT) having an alkyl chain length 12 or less, such as and capric acid (decanoic acid, C10), lauric acid (C12), caprylic acid (octanoic acid, C8) were able to achieve egg-like coagulation (and therefore textural properties such as firmness, toughness, resilience, and springiness as empirically confirmed by texture analyzer) and flavor. MCTs may be particularly beneficial for their health benefits. Surprisingly, egg substitute compositions including MCTs did not experience the alleged off-flavor reported by others, see, e.g., WO 2023009004, when using non-denatured potato protein (e.g., patatin) in combination with medium-chain fatty acids. This was confirmed by preparing formulations having 1% or more (e.g., 1.5% or more, 2% or more, etc., by mass) medium-chain fatty acids, by using increasing percentage of oils (e.g., coconut oil, palm oil, etc.) in the formulation. Without being bound by theory, this may be the result of controlling the pH within the mildly alkali range, as described above. For example, samples 1, 2 and 5 all have increasingly larger percentages of coconut oil, which is known to have a relatively high percentage of medium chain fatty acids, such as lauric acid and capric acid (decanoic acid). Coconut oil, on average, has been reported to have a percentage (by weight) of C12, C10 and C8 fatty acids of about 64%. This percentage is approximately the same (or just slightly lower) for palm oil. Thus, in Sample 5, shown in Table 2, above, the percentage (by weight) of medium chain fatty acids is approximately 3.5%.

The compositions described herein may therefore be enriched for medium-chain fatty acids having an alkyl chain length of 12 or less (e.g., between 12-8), so that the composition includes 2% or more by weight of fatty acids having a chain length of C12 or less (e.g., 2.1% or more, 2.2% or more 2.3% or more 2.4% or more, 2.5% or more, etc.).

### EXAMPLES

In some examples, a plant-based egg substitute composition may comprise 5% to 20% (w/w) protein (and in particular at least 5% of non-denatured protein isolate, such as non-denatured patatin); 0.01% to 5% chloride (w/w) (e.g., a chloride salt); and 0.01% to 15% (w/w) fat combined or combinable with 45% to 95% (w/w) water, and the pH may be adjusted to be between about 7.1 and about 7.8 (e.g., by including between 1% to 3% (w/w) calcium carbonate and/or between about 0.01 to 2% (w/w) tetrasodium pyrophosphate).

A plant-based egg substitute composition may be configured to substitute an egg scramble. For example, a plant-based egg substitute composition may comprise 68% to 72% (w/w) water; 5% to 11% (w/w) protein (e.g., non-denatured potato protein isolate); 1% to 8% (w/w) sunflower oil; optionally 2% to 6% (w/w) second protein (e.g., wheat protein); optionally 1% to 10% (w/w) coconut oil or palm oil; optionally 1% to 3% (w/w) inulin; 1% to 3% (w/w) calcium carbonate; 0.01 to 2% (w/w) tetrasodium pyrophosphate; 0.5% to 2.5% (w/w) lecithin (e.g., sunflower lecithin); 0.01% to 1.5% (w/w) chloride (e.g., NaCl); and optionally a colorant (e.g., 0.01% to 1% (w/w) beta carotene; 01% to 1% (w/w) titanium dioxide) and/or a flavor (e.g., 0.5% to 2% (w/w) egg flavoring, pea blocker, potato blocker, etc.). The pH may be between about 7.1 and 7.8.

A plant-based egg substitute composition may be configured to substitute an egg when used to bake. For example, a plant-based egg substitute composition may comprise 68% to 72% (w/w) water; 11% to 15% (w/w) protein (e.g., non-denatured potato protein isolate); 3% to 7% (w/w) sunflower oil and/or 3% to 8% coconut oil or palm oil; 1% to 3% (w/w) fiber (e.g., pea fiber); 0.5% to 2% (w/w) calcium carbonate; 0.5 to 2% (w/w) sodium acid pyrophosphate (tetrasodium pyrophosphate); 1.5% to 3.5% (w/w) lecithin (e.g., sunflower lecithin); 0.01% to 1% (w/w) beta carotene; 0.01% to 1% (w/w) titanium dioxide; and 0.01% to 1.5% (w/w) salt, and may have a pH between 7.1 and 7.8.

A plant-based egg substitute composition may be configured to substitute an egg white. For example, a plant-based egg substitute composition may comprise 80% to 86% (w/w) water; 9% to 13% (w/w) protein (e.g., non-denatured potato protein isolate); 1.75% to 3% (w/w) calcium carbonate; 0.5 to 2% (w/w) sodium acid pyrophosphate or tetrasodium pyrophosphate; 01% to 1% (w/w) titanium dioxide; 01% to 1.5% (w/w) salt. The pH may be between 7.1 and 7.8.

A plant-based egg substitute composition may be configured to substitute an egg yolk. For example, a plant-based egg substitute composition may comprise 50% to 55% (w/w) water; 11% to 15% (w/w) protein (e.g., non-denatured potato protein isolate); 14% to 18% (w/w) sunflower oil; 5% to 9% (w/w) coconut oil; 0.5% to 3% (w/w) calcium carbonate; 0.01 to 2% (w/w) sodium acid pyrophosphate or tetrasodium pyrophosphate; 0.5% to 2% (w/w) fiber (e.g., pea fiber); 2% to 6% (w/w) lecithin (e.g., sunflower lecithin); 0.01% to 1% (w/w) beta carotene; and 0.01% to 1.5% (w/w) salt. The pH may be between 7.1 and 7.8.

A plant-based egg substitute composition may be configured to substitute an egg yolk. For example, a plant-based egg substitute composition may comprise 8% to 13% (w/w) non-denatured potato protein; 3% to 10% (w/w) flour (e.g., wheat protein); 60% to 92% water; 0.25% to 3% (w/w) sodium chloride; 0% to 10% (w/w) sunflower oil; 0% to 3.5% (w/w) plant lecithin (e.g., sunflower lecithin). In some examples, any composition described herein may comprise a non-denatured potato protein less than 8% or greater than 13% based on one or more additional proteins included in the composition. The pH may be adjusted to be between 7.1 and 7.8, e.g., by using calcium carbonate, sodium acid pyrophosphate and/or tetrasodium pyrophosphate.

In some examples, any composition described herein may include one or more additional components such as one or more food gums (e.g., gellan gum, xanthan gum), psyllium (e.g., psyllium husks), salts (e.g., black salt, sodium chloride, tetrasodium pyrophosphate, sodium pyrophosphate), one or more flavoring agents (e.g., egg flavoring, pea blocker, potato blocker, etc.), one or more fibers (e.g., pea fiber), carrageenan, methyl cellulose, one or more polysaccharides, yeast (e.g., nutritional yeast), etc.

In some examples, any composition described herein can comprise one or more second proteins. In some examples, a concentration of one or more second proteins in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more hydrocolloids. In some examples, a concentration of one or more hydrocolloids in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween. In some examples, any composition described herein can comprise one or more protein isolates, including substantially non-denatured potato protein isolate. In some of the examples described herein the protein isolate may be referred to as a flour.

In some examples, any composition described herein can comprise one or more fibers. In some examples, a concentration of one or more fibers in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more salts. In some examples, a concentration of one or more salts in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween. In some examples, any composition described herein may comprise 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more emulsifiers. In some examples, a concentration of one or more emulsifiers in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more surfactants. In some examples, a concentration of one or more surfactants in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more fats. As described above, in particular, these compositions may include medium chain fatty acids, such as and capric acid (decanoic acid, C10), lauric acid (C12), caprylic acid (octanoic acid, C8), e.g., using palm oil and/or coconut oil. In some examples a concentration of one or more fats in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween. In some examples, one or more fats may be a plant-based oil such as sunflower oil, coconut oil, canola oil, a high linoleic acid oil, etc. In particular, these compositions may include 2% or more medium chain fatty acids, by weight.

In some examples, any composition described herein can comprise one or more polysaccharides. In some examples, a concentration of one or more polysaccharides in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more coloring agents. In some examples, a concentration of one or more coloring agents in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more leavening agents. In some examples, a concentration of one or more leavening agents in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more flavoring agents. In some examples, a concentration of one or more flavoring agents in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein can comprise one or more preservatives. In some examples, a concentration of one or more perseveres in any composition described herein may be 0% to 1% (w/w), 1% to 5% (w/w), 5% to 10% (w/w), 10% to 20% (w/w), 20% to 25% (w/w), 25% to 30% (w/w), or greater and/or including any range therebetween.

In some examples, any composition described herein may comprise one or more components in a ratio based on one or more other components of the composition. For example, the concentration of flour in a composition may be in a ratio based on the quantity of protein in the composition.

Any composition described herein may be configured to replace a traditional egg based on a replacement ratio. In particular, described herein are compositions that may replace a traditional egg for baking, frying and/or emulsification in a 1:1 ratio by weight (e.g., the same weight of egg as to egg replacement). A replacement ratio may refer to an amount quantity (e.g., weight or volume) of any composition described herein compared to an equivalent unit of quantity (e.g., weight or volume) of a traditional egg as a food product. For example, composition as described herein may replace a traditional egg (e.g., composition: traditional egg) with a replacement ratio of 0.1:1, 0.5:1, 1:1, 1:0.5, 1:0.1, etc. including any range therebetween.

In some examples, egg may refer to a natural egg. A natural egg may be an egg produced by natural biological processes associated with an animal (e.g., a chicken or duck).

In some examples, any composition described herein can comprise one or more components described here. Each of the components described herein may be extracted, obtain, derived from, or otherwise sourced from non-animal sources (e.g., plants). In some examples, any component described herein may be extracted, obtain, derived from, or otherwise sourced from one or more microorganisms.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An egg substitute composition comprising:
5% to 15% by weight of a substantially non-denatured potato protein isolate;
1% to 25% by weight of a fat;
0.3% to 3% by weight of chloride;
one or more of: calcium carbonate between 0.01%-3.5% by weight, tetrasodium pyrophosphate between 0.7%-1.3% by weight, and sodium acid pyrophosphate between 0.5 to 2% by weight; and
between 94% to 50% by weight of water,
wherein the pH is between 7.2 and 7.8, and wherein the egg substitute composition coagulates equivalently to a traditional egg.

2. The egg substitute composition of claim 1, wherein the substantially non-denatured potato protein isolate comprises non-denatured patatin.

3. The egg substitute composition of claim 1, wherein the substantially non-denatured potato protein isolate is 35% denatured or less.

4. The egg substitute composition of claim 1, wherein the fat comprises at least 2% medium chain fatty acids having an alkyl chain length 12 or less.

5. The egg substitute composition of claim 4, wherein the fat comprises 3% or more by weight of coconut oil.

6. The egg substitute composition of claim 4, wherein the fat comprises 3% or more by weight of palm oil.

7. The egg substitute composition of claim 1, wherein the egg substitute composition, when cooked to an internal temperature of between 160-170 degrees, has a firmness of within 35% that of traditional egg.

8. The egg substitute composition of claim 1, wherein the egg substitute composition, when cooked to an internal temperature of between 160-170 degrees, has a firmness of between 6800 g and 3200 g.

9. The egg substitute composition of claim 1, further comprising between 3% and 21% by weight of a second protein isolate.

10. The egg substitute composition of claim 1, further comprising a second protein isolate, wherein the total of the second protein isolate and the substantially non-denatured potato protein isolate is 16% by weight or less.

11. The egg substitute composition of claim 10, wherein the second protein isolate is one of: pea protein isolate, chickpea protein isolate, wheat protein isolate, lentil protein isolate, bean protein isolate, fava protein isolate, navy bean protein isolate, soy protein isolate, algal protein isolate, and/or seaweed protein isolate.

12. The egg substitute composition of claim 10, further comprising 1% to 15% by weight of pea protein isolate, wherein a total amount of pea protein isolate, and the substantially non-denatured potato protein isolate is 16% by weight or less.

13. The egg substitute composition of claim 1, further comprising one or more additional components, wherein each additional component is present at less than 3.5%, further wherein the additional components comprise: plant lecithin, low acyl gellan gum, high acyl gellan gum, psyllium, tetrasodium pyrophosphate, pea blocker, potato blocker, plant fiber, coconut oil, beta carotene, titanium dioxide, and xanthan gum.

14. The egg substitute composition of claim 1, further comprising one or more food colorants.

15. The egg substitute composition of claim 1, wherein the egg substitute composition does not include transglutaminase or methylcellulose.

16. The egg substitute composition of claim 1 configured for baking.

17. The egg substitute composition of claim 1, comprising: between 7%-15% by weight of the substantially non-denatured potato protein isolate comprising non-denatured patatin, between 0.01%-3.5% by weight of a plant lecithin, between 0.01%-3.5% by weight of a calcium carbonate, between 0.01%-3.5% by weight a pea fiber, between 0.35%-3.5% by weight of the chloride, between 0.7%-1.3% by weight of a tetrasodium pyrophosphate, and between 4%-10% by weight of the fat, wherein the fat comprises an oil.

18. The egg substitute composition of claim 17, wherein the oil comprises between 2%-10% by weight of sunflower oil and between 3%-10% by weight coconut oil.

19. The egg substitute composition of claim 1, further comprising, between 1%-3.5% by weight of an inulin.

20. The egg substitute composition of claim 1, wherein the egg substitute composition is configured as an egg yolk substitute.

21. A plant-based egg substitute composition, the composition comprising:
between 10%-15% by weight of a non-denatured potato protein isolate;
greater than 0.25% by weight of a chloride;
one or more of: calcium carbonate, between 0.01%-3.5% by weight, tetrasodium pyrophosphate between 0.7%-1.3% by weight, and sodium acid pyrophosphate between 0.5 to 2% by weight; and
water, wherein the egg substitute composition, when cooked to an internal temperature of between 160-170 degrees, has a firmness of within 35% that of traditional egg.

22. A method of making an egg substitute composition, the method comprising:
combining, into water, 5% to 15% by weight of a non-denatured potato protein isolate, 1% to 25% by weight of a fat, 0.25% to 3% by weight of chloride; and
adjusting the pH to be between 7.2 and 7.8 by adding one or more of: calcium carbonate, between 0.01%-3.5% by weight, tetrasodium pyrophosphate between 0.7%-1.3% by weight, and sodium acid pyrophosphate between 0.5 to 2% by weight,
wherein the egg substitute composition coagulates equivalently to a traditional egg.
